(19) United States
(12) Patent Application Publication
(10) Pub. No.: US 2024/0305047 A1
(43) Pub. Date: Sep. 12, 2024

(54) ELECTRICAL CONNECTOR

(71) Applicant: Amphenol East Asia Electronic Technology (Shenzhen) Co., Ltd., Shenzhen (CN)

(72) Inventors: Danren He, Shenzhen (CN); Kui Cai, Shenzhen (CN); Peng Wang, Shenzhen (CN)

(73) Assignee: Amphenol East Asia Electronic Technology (Shenzhen) Co., Ltd., Shenzhen (CN)

(21) Appl. No.: 18/599,013

(22) Filed: Mar. 7, 2024

(30) Foreign Application Priority Data
Mar. 10, 2023 (CN) 202310269566.3
Mar. 10, 2023 (CN) 202320523911.7

(51) Int. Cl. H01R 13/6582; H01R 12/71; H01R 13/627

(52) U.S. Cl. CPC H01R 13/6582; H01R 13/6273; H01R 12/716

(57) ABSTRACT

A modular connector system with components that can be economically assembled to both provide high signal integrity and supply reliable power in a harsh environment, such as an automobile. A connector includes a housing having a mating end, a back end, cavities extending from the mating end toward the back end, and latches extending inside the housing and having distal ends toward the back end. Signal and power terminal assemblies are disposed in respective cavities and engage respective latches. A signal terminal assembly includes a signal terminal, a signal cable attached to the signal terminal, and a shield substantially encircling the signal terminal and cable attachment. A power terminal assembly includes an insulative holder, a power terminal held in the insulative holder, and a power cable attached to the power terminal. Other disclosed techniques enable signal and power terminal assemblies stably and interchangeably disposed in the cavities.

### CROSS-REFERENCE TO RELATED APPLICATIONS

This application claims priority to and the benefit of Chinese Patent Application Serial No. 202320523911.7, filed Mar. 10, 2023. This application also claims priority to and the benefit of Chinese Patent Application Serial No. 202310269566.3, filed Mar. 10, 2023. The contents of these applications are incorporated herein by reference in their entirety.

### TECHNICAL FIELD

This patent application relates generally to interconnection systems, such as those including electrical connectors, used to interconnect electronic assemblies, and more specifically to electrical connectors for harsh environments, such as in a vehicle.

### BACKGROUND

Electrical connectors are used in many electronic systems. It is generally easier and more cost effective to manufacture a system as separate electronic assemblies, which may be joined together with electrical connectors. Connectors may be used for interconnecting assemblies so that the assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted in the printed circuit boards.

In some systems, connections between assemblies may be made through cables. The cables may be terminated with connectors that mate with connectors mounted on a printed circuit board. In this way, connections between assemblies may be made by plugging a connector that is part of cable assembly into a connector that is mounted to printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine, transmission (TCUs), security system, emissions control, lighting, advanced driver assistance system (ADAS), entertainment system, navigation system, and cameras. The ECUs may be manufactured as separate assemblies and connected over one or more vehicle networks formed with cables routed between these assemblies. To simplify manufacture of an automobile, the assemblies may be formed separately and then connected via cables that are terminated with connectors that enable connections to mating connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators or power switches. Noise can be particularly disruptive for high speed signals such as those used to communicate data over an automobile network.

### SUMMARY

Aspects of the disclosure relate to high speed connectors with integrated power.

Some embodiments relate to an electrical connector. The electrical connector may include a housing comprising a mating end, a back end opposite the mating end, a first cavity extending from the mating end toward the back and a second like cavity extending from the mating end toward the back; a signal terminal assembly disposed in the first cavity and comprising a signal terminal, and a shield substantially encircling the signal terminal; and a power terminal assembly disposed in the second cavity and comprising an insulative holder, and a power terminal held in the insulative holder, wherein the first and second cavities are symmetrical to each other such that the signal terminal assembly and power terminal assembly are interchangeable in the first and second cavities.

Optionally, the electrical connector may include a front cover comprising first and second openings disposed corresponding to the first and second cavities of the housing such that mating portions of the signal terminal assembly and power terminal assembly extend into respective openings of the front cover.

Optionally, the first and second openings of the front cover are symmetrical to each other such that the signal terminal assembly and power terminal assembly are interchangeable in the first and second cavities.

Optionally, the electrical connector may include a front seal disposed adjacent the front cover and abutting an annular surface of the housing.

Optionally, the electrical connector may include a position assurance component disposed in the housing and comprising third and fourth openings disposed corresponding to the first and second cavities of the housing such that cables ends of the signal terminal assembly and power terminal assembly extend into respective openings of the position assurance component.

Optionally, the third and fourth openings of the position assurance component are symmetrical to each other such that the signal terminal assembly and power terminal assembly are interchangeable in the first and second cavities.

Optionally, the signal terminal assembly comprises a signal cable having an end attached to the signal terminal and substantially encircled by the shield of the signal terminal assembly; the power terminal assembly comprises a power cable having an end attached to the power terminal; and the electrical connector comprises a rear seal abutting the position assurance component and comprising fifth and sixth openings disposed corresponding to the third and fourth openings of the position assurance component such that the signal cable and power cable extend through the fifth and sixth openings of the rear seal.

Optionally, the electrical connector may include a rear cover at least partially enclosing the rear seal and comprising seventh and eighth openings disposed corresponding to the fifth and sixth openings of the rear seal such that the signal cable and power cable extend out of the rear cover.

Optionally, a cross-section of the mating end of the power terminal assembly has an elliptical shape; and a cross-section of the back end of the power terminal assembly has a circular shape.

Optionally, the insulative holder comprises a channel; the power terminal is held in the channel of the insulative holder; and the power terminal assembly comprises a ferrule coupled to the insulative holder so as to retain the power terminal in the channel of the insulative holder.

Optionally, the insulative holder comprises an opening connected to the channel and a terminal position assurance component disposed in the opening and extending into the channel to engage the power terminal.

Some embodiments relate to a power terminal assembly. The power terminal assembly may include an insulative holder comprising a body with an elliptical cross section with a major axis, the body enclosing first and second channels and comprising a projection extending from the body orthogonally to the major axis; and a plurality of power terminals disposed within the first and second channels, each of the plurality of power terminals comprising a cuboid-shaped mating portion and a mounting portion configured to make electrical and mechanical connection to a power conductor.

Optionally, the insulative holder comprises first and second cantilevers extending from top and bottom of the body respectively; and the first and second cantilevers are each configured for engaging a support structure configured for supporting the power conductors positioned for electrical and mechanical connection to power terminals of the plurality of power terminals.

Optionally, for each of the plurality of power terminals, the mounting portion comprises a sheet and first and second tabs extending from opposite sides of the sheet.

Optionally, the power terminal assembly includes a ferrule comprising first and second curved tabs crimping the insulative holder from left and right and features at top and bottom engaging distal ends of the first and second cantilevers of the insulative holder so as to retain the pair of power terminals in position.

Optionally, the insulative holder comprises an opening at the top, the opening aligned with recesses between the cuboid-shaped mating portions and the first and second tabs of each of the plurality of power terminals; and the power terminal assembly comprises a terminal position assurance component disposed in the opening at the top of the insulative holder and extending into the recesses of each of the plurality of power terminals.

Optionally, the features at the top and bottom of the ferrule are openings; and the distal ends of the first and second cantilevers of the insulative holder comprises protrusions extending into the openings at the top and bottom of the ferrule.

Optionally, the power terminal assembly comprises a power cable comprising a plurality of wires attached to respective mounting portions of the plurality of power terminals, wherein the first and second tabs of the plurality of power terminals wrap respective wires of the pair of wires.

Optionally, each of the plurality of power terminals comprises third and fourth tabs extending from the opposite sides of the sheet; and the power cable comprises insulative layers enclosing respective wires of the plurality of wires and wrapped by the third and fourth tabs of respective power terminals of the plurality of power terminals.

Optionally, the power cable comprises a sheath enclosing the insulative layers; and a rear end of the ferrule crimps the sheath.

Optionally, the insulative holder has an elliptical cross-section; and the ferrule is in hollow cylindrical shape.

Some embodiments relate to an electrical connector. The electrical connector may include a housing comprising a mating end, a back opposite the mating end, first and second cavities extending from the mating end toward the back, and first and second latches inside the housing and having distal ends; a signal terminal assembly configured for insertion in the first cavity and engaging the first latch; a power terminal assembly configured for insertion in the second cavity and engaging the second latch; and a position assurance component disposed in the housing and comprising a first portion comprising a first opening configured to receive the distal end of the first latch and a second opening configured to receive the signal terminal assembly when the position assurance component is in an engaged position and a second portion comprising a third opening configured to receive the distal end of portion of the second latch and a fourth opening configured to receive the power terminal assembly when the position assurance component is in the engaged position.

Optionally, the power terminal assembly is configured for insertion in the first cavity and engaging the first latch; and the signal terminal assembly is configured for insertion in the second cavity and engaging the second latch.

Optionally, each of the signal terminal assembly and power terminal assembly comprises a projection extending downward; the first latch of the housing comprises a protrusion at the distal end and engaging the projection of the signal terminal assembly; and the second latch of the housing comprises a protrusion at the distal end and engaging the projection of the power terminal assembly.

Some embodiments relate to an electrical connector. The electrical connector may comprise a housing having a mating end and a back end opposite each other along an axis. The housing may be provided with one or more mounting cavities each having a structure configured to receive a contact carrier for high speed signals. A power terminal assembly may be shaped for insertion into a mounting cavity such that an electrical connector may be assembled with at a power terminal assembly in at least one of the mounting cavities.

In some examples, the mounting cavities may extend from the mating end to the back end. In such a configuration, the power terminal assembly may be inserted from the back, opposite the mating end, which is the back end of the connector in this example.

Optionally, the power terminal assembly may include an insulative holder provided with a channel parallel to the axis, a power terminal inserted into the channel from a side corresponding to the back end, and a ferrule. The power terminal may include a mating portion facing the mating end and a cable connection portion facing the back end. The cable connection portion may be configured for connection to a power cable. The ferrule may be connected to the insulative holder from the side corresponding to the back end to retain the power terminal within the channel.

Optionally, the insulative holder may be provided with an opening. The power terminal may be provided with a first recess aligned with the opening, and a terminal position assurance component may be mounted into the opening and the first recess to prevent the power terminal from exiting the channel.

Optionally, the terminal position assurance component may be connected to the insulative holder by a connecting portion and aligned with the opening before being mounted in place. The connecting portion may be capable of being cut or bent under an external force.

Optionally, the cable connection portion may include a mounting portion extending from an edge of the mating portion toward the back end. A first tab may be disposed at a side edge of the mounting portion and configured for being crimped to a wire of a power cable. The first tab may be spaced apart from the mating portion to form the first recess.

Optionally, the power cable may further include an insulating layer wrapped around the wire and an insulating sheath as an outermost layer. The power cable may have a terminated end connected to the cable connection portion of the power terminal. The terminated end may be configured such that the wire protrudes beyond the insulating layer and the insulating layer protrudes beyond the insulating sheath. The mounting portion may be further provided with a second tab at the side edge, and the second tab may be crimped to the insulating layer. The ferrule may be crimped to the insulating sheath.

Optionally, there may be two first tabs disposed on two side edges of the mounting portion respectively, and at least portions of the two first tabs may overlap each other.

Optionally, the ferrule may be in hollow cylindrical shape. The insulative holder may be provided with a cantilever extending into the ferrule. A distal end of the cantilever may have a holder engaging portion. An opening may be disposed in a sidewall of the ferrule. The holder engaging portion may be engaged with the opening.

Optionally, the cantilever may include a first cantilever and a second cantilever opposite each other on two sides of the insulative holder.

Optionally, there may be a plurality of channels spaced apart by a divider inside the insulative holder. The divider may extend to middles of the first cantilever and the second cantilever along a direction parallel to the axis. The divider may be connected between the first cantilever and the second cantilever.

Optionally, the first cantilever may have a first inner surface facing the power terminal and a first outer surface being back to the power terminal. The second cantilever may have a second inner surface facing the power terminal and a second outer surface being back to the power terminal. The second inner surface may be provided with a rib connected to the divider and parallel to the axis. A maximum distance from the first inner surface to the first outer surface may be greater than a maximum distance from the second inner surface to the second outer surface.

Optionally, the cable connection portion may include a mounting portion extending from a edge of the mating portion toward the back end. Tabs may be oppositely disposed on two side edges of the mounting portion. The tabs may be crimped onto a wire of the power cable and oriented toward the second inner surface.

Optionally, an end of the ferrule may be provided with a terminal crimping portion extending toward the insulative holder. The terminal crimping portion may be alternately disposed with the cantilever along a direction around the power terminal. The terminal crimping portion may be crimped onto the power terminal and/or the power cable connected to the power terminal.

Optionally, the terminal crimping portion may include a curved tab extending around the axis and a connecting portion connected between the curved tab and the ferrule, and the curved tab may be crimped onto the power terminal and/or the power cable connected to the power terminal.

Optionally, the insulative holder may have a cross-section perpendicular to the axis and in an elliptical shape. The insulative holder may have a first side and a second side opposite each other along a short axis of the elliptical shape, and the cantilever may be disposed on the first side and/or the second side.

Optionally, the insulative holder may have a cross-section perpendicular to the axis and in an elliptical shape. The insulative holder may have a first side and a second side opposite each other along a short axis of the elliptical shape. A projection may be disposed on an outer surface of the first side and/or an outer surface of the second side, and locked with the housing.

Optionally, the electrical connector may further comprise a power cable including a wire inside and an insulating sheath outside. The ferrule in a hollow cylindrical shape may be sleeved and crimped onto an end of the insulating sheath. The wire may protrude beyond the end of the insulating sheath and be secured to the power terminal. The insulative holder may abut against the end of the insulating sheath.

Optionally, each of at least one of the other mounting cavities of the mounting cavities may be inserted with a signal terminal assembly.

Optionally, the housing may comprise a main housing provided with a contact position assurance component, and the signal terminal assembly and the power terminal assembly may be retained in the main housing by the contact position assurance component.

Optionally, a first projection may be disposed on an outer sidewall of the power terminal assembly. A first projection may be disposed on an outer sidewall of the signal terminal assembly. The contact position assurance component may include a latch extending toward the back end. The latch may have a housing engaging portion at a distal end thereof.

The housing engaging portion may be engaged with the first projection and the first projection to prevent the signal terminal assembly and the power terminal assembly from exiting the main housing.

Optionally, a gap may be provided between an inner sidewall of the main housing and the latch. The housing may further comprise a position assurance component inserted into the main housing. The mounting cavities may be formed by both the position assurance component and the main housing. The position assurance component may be inserted into the gap.

Optionally, a second projection may be disposed on the outer sidewall of the power terminal assembly, and a second projection may be disposed on the outer sidewall of the signal terminal assembly. The contact position assurance component may include a protruding portion. The second projection and the second projection may abut against the protruding portion to limit the second projection and the second projection along a direction toward the mating end.

Optionally, front ends of the power terminal assembly and the signal terminal assembly may extend beyond the mating end of the housing, and portions of the power terminal assembly and the signal terminal assembly accommodated in the mounting cavities may have the same outer contour.

Some embodiments relate to an electrical connector. The electrical connector may comprise a housing having a mating end and a back end opposite each other along an axis, and a power terminal assembly and a signal terminal assembly inserted from the back end into the housing. Portions of the power terminal assembly and the signal terminal assembly within the housing may have the same outer contour such that the power terminal assembly and the signal terminal assembly are interchangeably positioned.

Optionally, the power terminal assembly may comprise an insulative holder provided with a channel parallel to an axis of the housing, a power terminal inserted from a side corresponding to the back end into the channel, and a ferrule. The power terminal may include a mating portion facing the mating end and a cable connection portion facing the back end. The cable connection portion may be configured for connection to a power cable. The ferrule may be connected to the insulative holder from the side corresponding to the back end to retain the power terminal end within the channel.

Optionally, the insulative holder may be provided with an opening, and the power terminal may be provided with a first recess aligned with the opening. A terminal position assurance component may be mounted into the opening and the first recess to prevent the power terminal from exiting the channel.

Optionally, the terminal position assurance component may be connected to the insulative holder by a connecting portion and aligned with the opening before being mounted in place. The connecting portion may be capable of being cut or bent under the action of an external force.

Optionally, the cable connection portion may include a mounting portion extending from an edge of the mating portion toward the back end. A first tab may be disposed at a side edge of the mounting portion and configured for being crimped to a wire of a power cable. The first tab may be spaced apart from the mating portion to form the first recess.

Optionally, the power cable may further comprise an insulating layer wrapped around the wire and an insulating sheath as an outermost layer. The power cable may have a terminated end connected to the cable connection portion of the power terminal. The terminated end may be configured such that the wire protrudes beyond the insulating layer and the insulating layer protrudes beyond the insulating sheath. The mounting portion may be further provided with a second tab at the side edge, and the second tab may be crimped to the insulating layer. The ferrule may be crimped to the insulating sheath.

Optionally, the housing may comprise a main housing provided with a contact position assurance component, and the signal terminal assembly and the power terminal assembly may be retained in the main housing by the contact position assurance component.

Optionally, a first projection may be disposed on an outer sidewall of the power terminal assembly, and a first projection may be disposed on an outer sidewall of the signal terminal assembly. The contact position assurance component may include a latch extending toward the back end. The latch may have a housing engaging portion at a distal end thereof.

The housing engaging portion may be engaged with the first projection and the first projection to prevent the signal terminal assembly and the power terminal assembly from exiting the main housing.

Optionally, a gap may be provided between an inner sidewall of the main housing and the latch. The housing may further comprise a position assurance component inserted into the main housing. The position assurance component may be inserted into the gap.

Optionally, a second projection may be disposed on the outer sidewall of the power terminal assembly, and a second projection may be disposed on the outer sidewall of the signal terminal assembly. The contact position assurance component may include a protruding portion. the second projection and the second projection may abut against the protruding portion to limit the second projection and the second projection along a direction toward the mating end.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a perspective view of an electrical connector, according to some embodiments;

FIG. 1B is a front view of the electrical connector of FIG. 1A;

FIG. 2 is an exploded perspective view of the electrical connector of FIG. 1A;

FIG. 3A is a cross-sectional view of FIG. 1B taken by a line marked “A-A” in FIG. 1B;

FIG. 3B is a cross-sectional view of FIG. 1B taken by a line marked “B-B” in FIG. 1B;

FIG. 4 is a cross-sectional perspective view of a housing of the electrical connector of FIG. 1A;

FIG. 5 is a perspective view of a front cover of the electrical connector of FIG. 1A;

FIG. 6 is a perspective view of an electrical connector, with positions of a power terminal assembly and a signal terminal assembly switched with respect to FIG. 1A, according to some embodiments;

FIG. 7 is an exploded perspective view of a power terminal assembly of the electrical connector of FIG. 1A or 6;

FIG. 8 is a perspective view of the power terminal assembly of FIG. 7;

FIG. 9 is a front view of the power terminal assembly of FIG. 8;

FIG. 10 is a cross-sectional view of the power terminal assembly of FIG. 8 taken by a line marked “E-E” in FIG. 9;

FIG. 11 is a cross-sectional view of the power terminal assembly of FIG. 8 taken by a line marked “K-K” in FIG. 9;

FIG. 12 is a perspective view of an insulative holder of the power terminal assembly of FIG. 8;

FIG. 13 is another perspective view of the insulative holder of FIG. 12;

FIG. 14 is yet another perspective view of the insulative holder of FIG. 12;

FIG. 15 is a front view of the insulative holder of FIG. 12;

FIG. 16 is a cross-sectional view of the insulative holder of FIG. 12 taken by a line marked “C-C” in FIG. 15;

FIG. 17 is a perspective view of a power terminal of the power terminal assembly of FIG. 9;

FIG. 18 is a cross-sectional view of the power terminal of FIG. 17;

FIG. 19 is a perspective view of a ferrule of the power terminal assembly of FIG. 8;

FIG. 20 is a cross-sectional view of the ferrule;

FIG. 21 is a side view of a signal terminal assembly of the electrical connector of FIG. 1A or 6;

FIG. 22 is a partially exploded perspective view of the electrical connector of FIG. 1A, showing the power terminal assembly and signal terminal assembly mounted to a main housing;

FIG. 23 is a top view of the electrical connector of FIG. 22, showing a rear cover and a position assurance component mounted to the main housing;

FIG. 24 is a cross-sectional view of the electrical connector of FIG. 23 taken by a line marked “D-D” in FIG. 23; and

FIG. 25 is a perspective view of the electrical connector of FIG. 1A, showing a front cover to be mounted to the main housing.

The above accompanying drawings include the following reference signs:
10, electrical connector; 100, housing; 101, mating end; 102, back end; 103, cavity; 104, gap; 110, main housing; 112, latch; 1121, housing engaging portion; 120, position assurance component; 131, positioning hole; 132, engaging portion; 133, annular groove; 140, protruding portion; 200, power terminal assembly; 210, insulative holder; 211, channel; 211a, end; 211b, flange; 212, opening; 213, terminal position assurance component; 214, connecting portion; 215, cantilever; 2151, first cantilever; 2151a, first inner surface; 2151b, first outer surface; 2152, second cantilever; 2152a, second inner surface; 2152b, second outer surface; 216, holder engaging portion; 217, divider; 218, rib; 219, projection; 219a, first projection; 219b, second projection; 220, power terminal; 221, mating portion; 222, cable connection portion; 2221, mounting portion; 2221a, first portion; 2221b, second portion; 2222, first tab; 2223, second tab; 223, groove; 230, ferrule; 231, opening; 232, first end; 233, second end; 234, first terminal crimping portion; 234a, first curved tab; 234b, first connecting portion; 235, second terminal crimping portion; 235a, second curved tab; 235b, second connecting portion; 260, power cable; 261, wire; 262, insulating layer; 263, insulating sheath; 300, signal terminal assembly; 310, first projection; 320, second projection; 360, signal cable; 500, rear seal; 510, first threaded hole; 520, second threaded hole; 511, first flange; 521, second flange; 600, rear cover; 610, first hole; 620, second hole; 700, front seal; 800, front cover; 810, first opening; 820, second opening; 830, post; 840, housing engaging portion.

### DETAILED DESCRIPTION

The inventors have recognized and appreciated techniques for making a hybrid connector for providing both high speed signal and high voltage power that may be economically manufactured yet operates reliably in the harsh environment presented by an automobile. The inventors have recognized and appreciated various techniques that may be applied to components of the connector system to provide connections with high signal integrity at high speed while providing reliable power simultaneously in the vicinity of the signal transmission paths.

An electrical connector may have a plurality of terminal assemblies arranged in an array. For example, two terminal assemblies may be disposed side by side and form a 1×2 array. As another example, four terminal assemblies may be arranged in two rows and two columns and form a 2×2 array. Some of the terminal assemblies may be configured for signal transmission; and others may be configured for power transmission.

The signal and power terminal assemblies may be stably and interchangeably disposed in the housing. For example, when the electrical connector needs to mate with another electrical connector mounted onto a printed circuit board (PCB) with a different wiring, which may determine respective numbers and/or positions of signal and power terminal assemblies, techniques described herein can enable adapting the connector according to the wiring of the PCB, so as to avoid the need to either redesign the connector according to the PCB or redesign the PCB according to the connector.

In some embodiments, an electrical connector may include a housing having a mating end, a back end, cavities extending from the mating end toward the back end, and latches extending inside the housing and having distal ends toward the back end. Signal and power terminal assemblies may be disposed in respective cavities and engage respective latches. A signal terminal assembly may include a signal terminal, a signal cable attached to the signal terminal, and a shield substantially encircling the signal terminal and cable attachment. A power terminal assembly may include an insulative holder, a power terminal held in the insulative holder, and a power cable attached to the power terminal. The insulative holder may be configured to both hold the power terminal and match the dimensions of the signal terminal assembly such that the power terminal assembly can be interchangeable with the signal terminal assembly. The power terminal assembly may also have a terminal position assurance component configured to retain the power terminal in desired position in the insulative holder. The connector may include a position insurance component disposed in the housing and comprising respective portions enclosing engagement portions of the latches and corresponding terminal assemblies. The position insurance component can also be configured to provide desired isolation between signal transmission paths and power transmission paths by, for example, using material with desired electric constant. Components of the connector may be configured to have a symmetrical structure such that the signal and power terminal assemblies can be interchangeably disposed in the cavities.

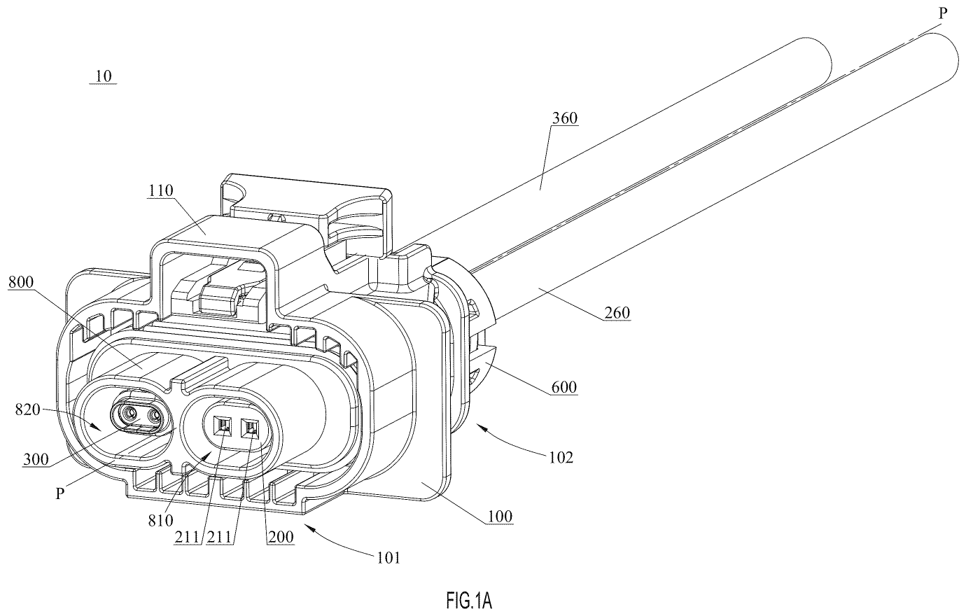

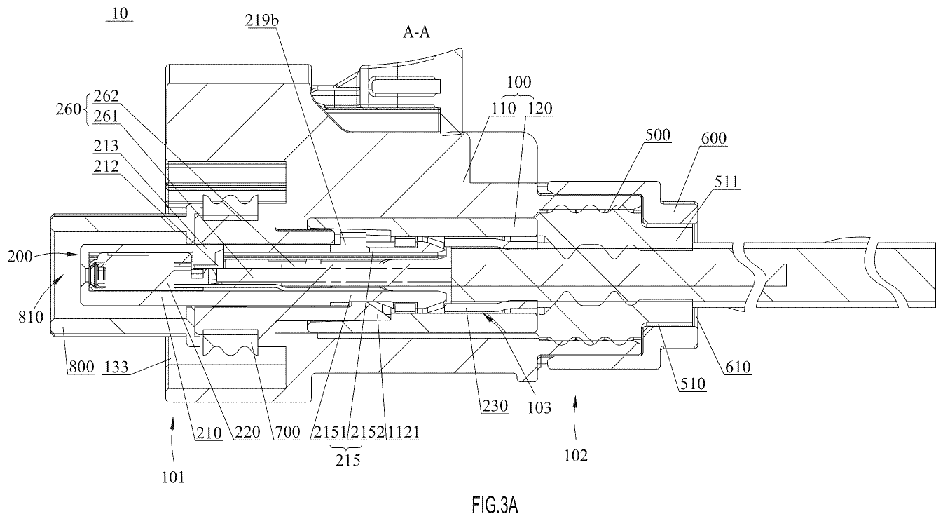

FIGS. 1A-1B, 2 and 3A-3B illustrate a cable electrical connector 10 according to an exemplary embodiment of the present disclosure. As shown, the electrical connector 10 may comprises a housing 100. The housing 100 may be molded from an insulating material, such as plastic, or any other suitable material. The housing 100 may comprise separated pieces. Exemplarily, the housing 100 may include a main housing 110 and a position assurance component 120. The position assurance component 120 is mounted into the main housing 110. The position assurance component 120 may also be made of an insulating material. FIG. 4 illustrates a sectional perspective view of the main housing 110 and the position assurance component 120 mounted together. Exemplarily, the housing may also be an integrated piece. The housing 100 may have a mating end 101 and a back end 102 opposite each other along an axis P-P. One or more mounting cavities 103 having the same structure may be disposed inside the housing 100. In the illustrated example, the cavities 103 are like each other in that both are sized to receive terminal assemblies of the same size and shape and each has attachment features for holding the terminal assemblies in the housing. The mounting cavities 103 each may extend from the mating end 101 to the back end 102. As illustrated in FIG. 4, the mounting cavities 103 may be formed by both the main housing 110 and the position assurance component 120. Portions of the mounting cavities 103 may be formed in the main housing 110 and the other portions may be formed in the position assurance component 120. In the illustrated embodiment, there are two mounting cavities 103. Optionally, there may be a cavity 103, or three or more mounting cavities 103. Where there are a plurality of mounting cavities 103, the mounting cavities 103 may have the same structure such that the mounting cavities 103 are capable of receiving terminal assemblies having the same structure. The terminal assemblies may include one or more of a power terminal assembly 200 and a signal terminal assembly 300.

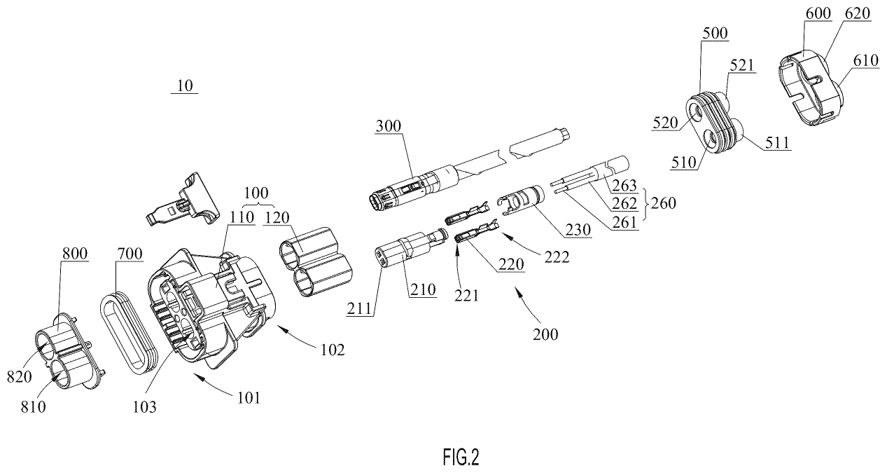

At least one mounting cavity 103 may be inserted with the power terminal assembly(s) 200. The power terminal assembly 200 is inserted into the cavity 103 from the back end 102. Exemplarily, each of at least part of the other mounting cavities 103 may be inserted with the signal terminal assembly 300, as shown in FIGS. 1A-1B. In the illustrated embodiment, the housing 100 is provided with two mounting cavities 103. One cavity 103 is provided with the power terminal assembly 200 inside, and the other cavity 103 is provided with the signal terminal assembly 300 inside. The power terminal assembly 200 may be connected to a conductive element, such as a power cable 260. The signal terminal assembly 300 may be connected to a conductive element, such as a signal cable 360. The back end 102 may be oriented toward the power cable 260 and the signal cable 360. The mating end 101 is oriented toward a mated electrical connector. The power terminal assembly 200 and the signal terminal assembly 300 may extend beyond the mating end 101 of the housing 100 to electrically contact a power terminal assembly and a signal terminal assembly of the mated electrical connector. During assembling, the power terminal assembly 200 and the signal terminal assembly 300 may be inserted into the mounting cavities 103 from the back end 102 of the housing 100. After the power terminal assembly 200 and the signal terminal assembly 300 are inserted in place in respective mounting cavities 103, a rear cover 600 may be connected to the back end 102 of the housing 100, as shown in FIGS. 3A-3B and 4. The rear cover 600 may not only confine the power terminal assembly 200 and the signal terminal assembly 300 within the housing 100, but also serve as a seal. The rear cover 600 may be connected to the back end 102 of the housing 100 by any suitable means, such as snap, fastener, ultrasonic welding, and the like.

The sum of the power terminal assembly(s) 200 and signal terminal assembly(s) 300 may be equal to the number of the mounting cavities 103. Optionally, the sum of the power terminal assembly(s) 200 and signal terminal assembly(s) 300 may also be less than the number of the mounting cavities 103, in which case, a cavity(s) 103 may be unused. The signal terminal assembly 300 and the power terminal assembly 200 may have substantially the same outer contour, or portions of the signal terminal assembly 300 and the power terminal assembly 200 at least inside the mounting cavities 103 may have substantially the same outer contour.

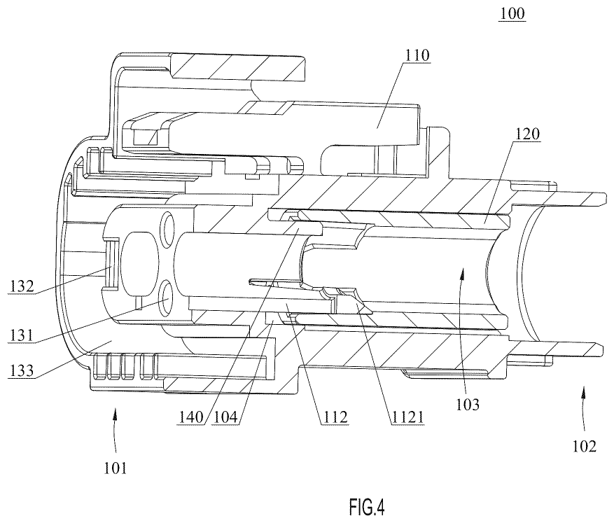

Since each of the mounting cavities 103 is suitable for receiving the signal terminal assembly 300, by enabling the power terminal assembly 200 to be mounted into any cavity 103, the signal terminal assembly 300 and the power terminal assembly 200 can be integrated into the electrical connector 10. Optionally, a housing for holding the signal terminal assembly 300 can be assembled with the power terminal assembly 200 to form an electrical connector for transmitting power only. Anyway, power can be reliably transmitted between electronic devices interconnected by an interconnection system including the electrical connector. In addition, the power terminal assembly 200 may be mounted into any expected cavity 103 as needed. As shown in FIG. 6, the positions of the power terminal assembly 200 and the signal terminal assembly 300 in the housing 100 may be interchanged. Optionally, one or more of the mounting cavities 103 may be left unused, e.g., with no terminal assembly disposed therein, if needed. By designing the power terminal assembly 200 with a structure capable of being mounted to the cavity 103, the housing 100 has greater versatility.

Optionally, a rear seal 500 may be disposed between the rear cover 600 and the back end 102 of the housing 100. Exemplarily, the rear seal 500 may be a seal ring. The rear seal 500 may be sleeved over the power cable 260 and the signal cable 360, and assembled into the back end 102 of the housing 100 in interference fit. After the rear cover 600 is connected to the housing 100, the rear seal 500 may be retained in the housing 100. To improve sealing performance, the rear seal 500 may be provided with a first threaded hole 510 and a second threaded hole 520 corresponding to the power cable 260 and the signal cable 360, respectively, and a first flange 511 and a second flange 521 extend backward from the edges of the first threaded hole 510 and the second threaded hole 520. The first flange 511 and the second flange 521 may extend from the first hole 610 and the second hole 620 in the rear cover 600, respectively, to form seals between the rear cover 600 and the power cable 260 and between the rear cover 600 and the signal cable 360.

Exemplarily, the portions of the power terminal assembly 200 and the signal terminal assembly 300 accommodated inside the housing 100 may have the same outer contour. This may thereby allow interchange of the positions of the power terminal assembly 200 and the signal terminal assembly 300 in the housing 100. The mating end 101 of the housing 100 may be connected with a front cover 800. In the case where front ends of the power terminal assembly 200 and the signal terminal assembly 300 protrude beyond the mating end 101 of the housing 100, to avoid electrical shock and for protection of protruding ends of the power terminal assembly 200 and the signal terminal assembly 300, the front cover 800 may enclose the peripheral sides of the power terminal assembly 200 and the signal terminal assembly 300. The terminal assemblies in the mated electrical connector may be allowed to be inserted into the front cover 800 in a direction parallel to the axis P-P, and electrically contact with the power terminal assembly 200 and the signal terminal assembly 300. The front cover 800 may be provided with a first opening 810 and a second opening 820 in one-to-one correspondence with the power terminal assembly 200 and the signal terminal assembly 300. The front ends of the power terminal assembly 200 and the signal terminal assembly 300 are inserted into the first opening 810 and the second opening 820, respectively, and are shorter than the first opening 810 and the second opening 820, respectively. An inner sidewall of the first opening 810 is spaced apart from an outer sidewall of the front end of the power terminal assembly 200 to form a space for receiving the power terminal assembly of the mated electrical connector. An inner sidewall of the second opening 820 is spaced apart from an outer sidewall of the front end of the signal terminal assembly 300 to form a space for receiving the signal terminal assembly of the mated electrical connector.

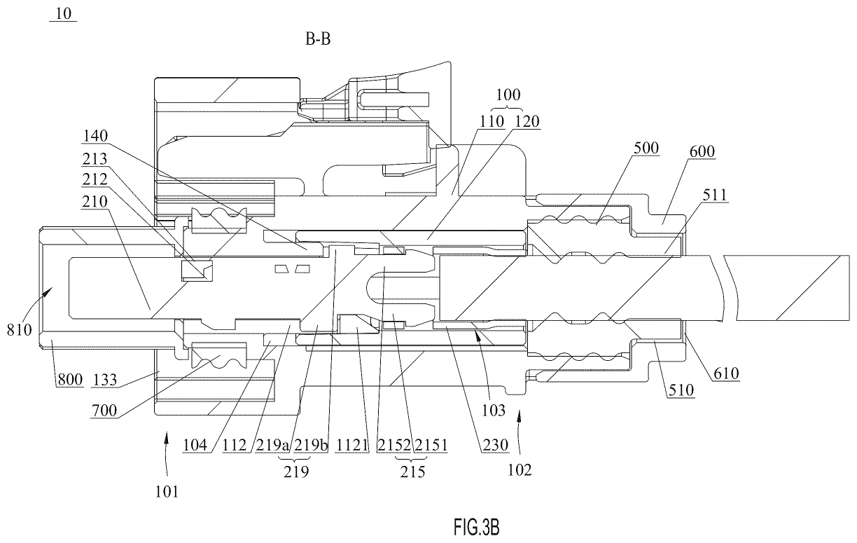

In some embodiments, the front cover 800 may be provided with a post 830, as shown in FIG. 5, and the mating end 101 of the housing 100 may be provided with a positioning hole 131, as shown in FIG. 4. In addition, the front cover 800 may be provided with a housing engaging portion 840, and the mating end 101 of the housing 100 may be provided with an engaging portion 132. When the front cover 800 is mounted to the housing 100, the post 830 is inserted into the positing hole 131, and the housing engaging portion 840 is engaged with the engaging portion 132. Optionally, the positions of the positioning hole and post may be interchangeable, e.g., a post may be disposed on the housing 100, and a positioning hole may be disposed in the front cover 800. Optionally, a front seal 700 may be provided between the front cover 800 and the mating end 101 of the housing 100.

Exemplarily, the front seal 700 may be a seal ring. The front seal 700 may be clamped between the front cover 800 and the mating end 101 of the housing 100 in the direction parallel to the axis P-P. The front seal 700 may be disposed around both the power terminal assembly 200 and the signal terminal assembly 300. Exemplarily, as shown in FIGS. 3A-3B and 4, the mating end 101 of the housing 100 may be provided with an annular groove 133 surrounding both the power terminal assembly 200 and the signal terminal assembly 300, and the front seal 700 is inserted into the annular groove 133. The front seal 700 abuts against an inner peripheral wall of the annular groove 133 and is spaced apart from an outer peripheral wall of the annular groove 133. The front seal 700 may close any gap between the front cover 800 and the housing 100. The spaced-apart space may receive the mating end of the housing of the mated electrical connector. When the mating end of the housing of the mated electrical connector is inserted into the spaced-apart space, the front seal 700 may form a seal along a radial direction between the housing of the mated electrical connector and the housing 100 of the electrical connector 10.

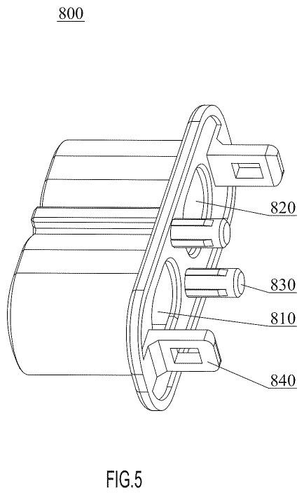

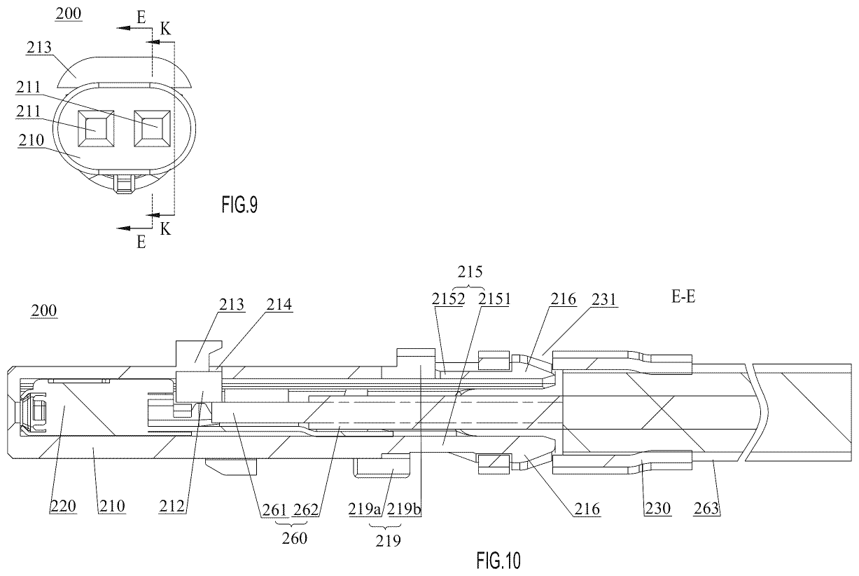

Exemplarily, as shown in FIGS. 7 to 11, the power terminal assembly 200 may include an insulative holder 210, power terminals 220, and a ferrule 230. The insulative holder 210 may be provided with channels 211 parallel to the axis P-P. The power terminals 220 may be inserted into the insulative holder 210 from a side corresponding to the back end 102. The power terminals 220 each may include a mating portion 221 facing the mating end 101 and a cable connection portion 222 facing the back end 102. The cable connection portion 222 may be used to connect the power cable 260. The ferrule 230 may be connected to the insulative holder 210 at the side corresponding to the back end 102 to retain the power terminals 220 within the channels 211. The power cable 260 may include a wire 261 and an insulating sheath 263 covering over the wire 261. Optionally, two wires 261 may be wrapped by the insulating sheath 263 for connection to positive and negative terminals of a power supply, respectively. In this case, each wire 261 may be provided with an insulating layer 262. The insulating sheath 263 may be disposed outside the insulating layers 262. The insulating sheath 263 and the insulating layer 262 may be stripped from the end of the power cable 260 to be terminated to the power terminal 220 to expose a portion of the wire 261. Each of the insulating layer 262 and the wire 261 has a portion exposed beyond the insulating sheath 263, and the wire 261 is also exposed beyond the insulating layer 262. Optionally, the stripped insulating sheath 263 may be folded backward to cover a rearward adjacent portion of the power cable 260. The ferrule 230 may be crimped onto the folded insulating sheath 263. Optionally, if the stripped insulating sheath 263 is removed, the ferrule 230 may be crimped directly onto the insulating sheath 263 of the power cable 260. The ferrule 230 may be made of a metallic material to facilitate crimping of the ferrule 230 onto the power cable 260. The cable connection portion 222 of the power terminal 220 may be crimped onto the power cable 260, for example, onto both the exposed insulating layer 262 and the wire 261. Optionally, it is also possible that the cable connection portion is crimped only onto the exposed wire 261. The power terminal 220 may be made of a conductive material, such as metal. It is also possible to bring the power terminal 220 into electrical contact with the wire 261 when the cable connection portion 222 of the power terminal 220 is crimped onto the wire 261. An insulative holder 210 may be made of an insulating material. The insulative holder 210 not only fixes the power terminal assembly 200 to the housing 100, but also ensures that adjacent wires 261 are insulated from each other.

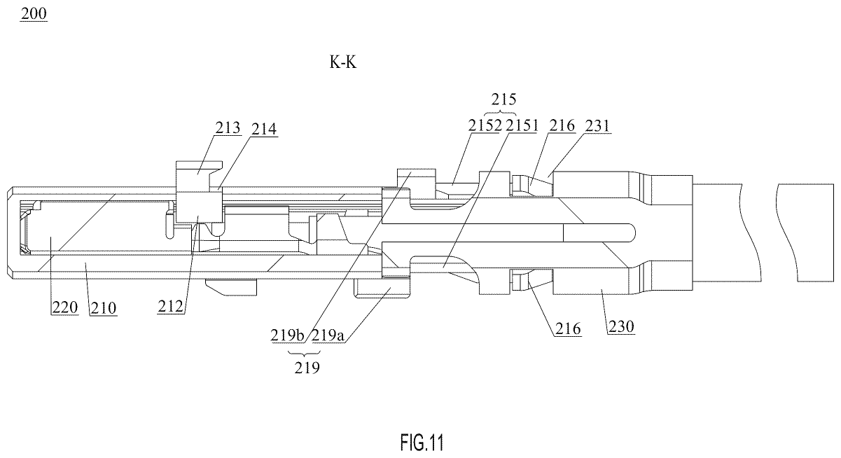

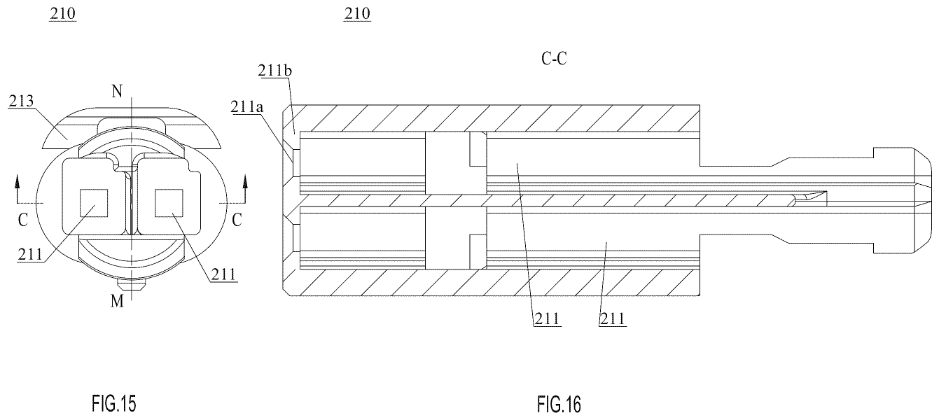

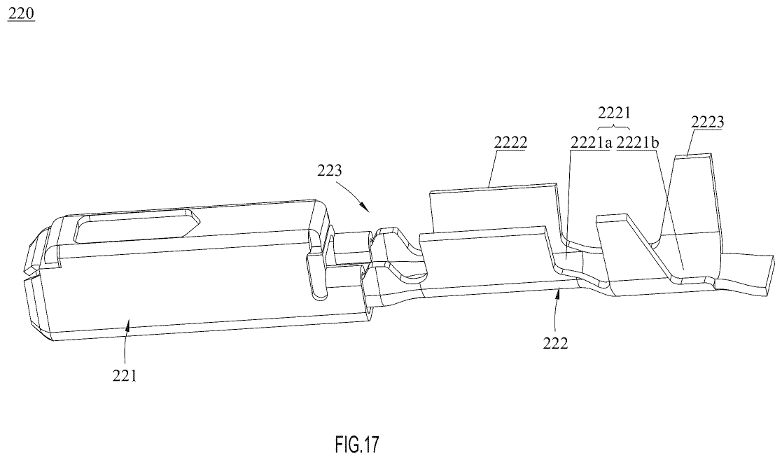

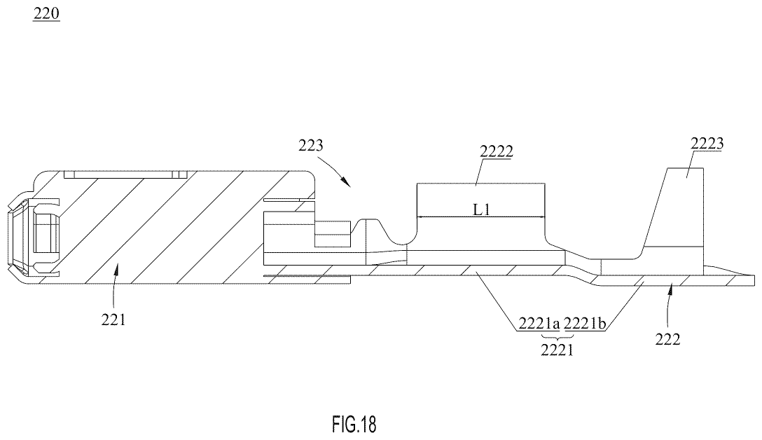

Exemplarily, as shown in FIGS. 7 to 16, the insulative holder 210 may be provided with an opening 212. Optionally, the opening 212 may be disposed on an end of the insulative holder 210 that is away from the back end 102. As shown in FIGS. 17 and 18, the power terminal 220 may be provided with a first recess 223 aligned with the opening 212. A terminal position assurance component 213 may be provided in the opening 212. FIGS. 7 to 16 illustrate a state before the terminal position assurance component 213 is mounted into the opening 212 in place, and the terminal position assurance component 213 is to be inserted into the opening 212 after the mounting is completed, as shown in FIGS. 3A-3B. The terminal position assurance component 213 may also be inserted into the first recess 223 to prevent the power terminal 220 from exiting the channel 211. As shown in FIG. 16, at the end of the insulative holder 210 toward the mating end 101, a cross-section of an end 211a of the channel 211 may be smaller than a cross-section of the other portion of the channel 211 to form a flange 211b at the end 211a of the channel 211. Optionally, the flange 211b and the insulative holder 210 may be formed integrally. After the terminal position assurance component 213 is inserted into the channel 211 in place, the power terminal 220 may abut against the flange 211b. Thereupon, under the cooperation of the flange 211b and the terminal position assurance component 213, the power terminal 220 may be firmly fixed in the channel 211. The terminal position assurance component 213 may be fixed into the opening 212 and the first recess 223 by any suitable means such as interference fit, adhesive or fastener connection. In assembly, the power terminal 220 is inserted into the channel 211 in the insulative holder 210 first, and then the terminal position assurance component 213 is inserted into the opening 212 and the first recess 223 to lock the insulative holder 210 with the power terminal 220, and finally the ferrule 230 is connected to the insulative holder 210, thereby completing the assembly of the power terminal assembly 200. Optionally, it is possible to connect the ferrule 230 to the insulative holder 210 first, at which time the power terminal 220 can also be retained in the channel 211, and then to mount the terminal position assurance component 213. The terminal position assurance component 213 and the ferrule 230 may provide a double locking function for the power terminal 220. Upon the completion of assembly, the power terminal assembly 200 is inserted into the cavity 103 of the housing 100. The outer contour of the power terminal assembly 200 is adapted to the shape of the cavity 103. The sidewalls of the cavity 103 restrict the terminal position assurance component 213 from exiting the opening 212 and the first recess 223. The terminal position assurance component 213 may be adapted to the opening 212 and the first recess 223 in shape without having to be interference-fitted into them, so that the terminal position assurance component 213 can be mounted to the opening 212 and the first recess 223 with a very small external force exerted thereon, which makes the assembly much easier. It is also more tolerant of manufacturing tolerances.

Optionally, the structure of the terminal position assurance component 213 may also be rationally designed so that it is extruded into the opening 212 and the first recess 223 by the sidewalls of the cavity 103 during insertion of the power terminal assembly 200 into the cavity 103 from the back end 102. For example, a bevel or chamfer may be provided on a side of the terminal position assurance component 213 facing the mating end 101. Before the power terminal assembly 200 is inserted into the cavity 103, the terminal position assurance component 213 can be pre-positioned above the opening 212. As the power terminal assembly 200 moves into the cavity 103, the bevel or the chamfer first contacts the sidewall of the cavity 103. The terminal position assurance component 213 is gradually mounted in place, as the sidewall of the cavity 103 continues to slide relative to the bevel or the chamfer.

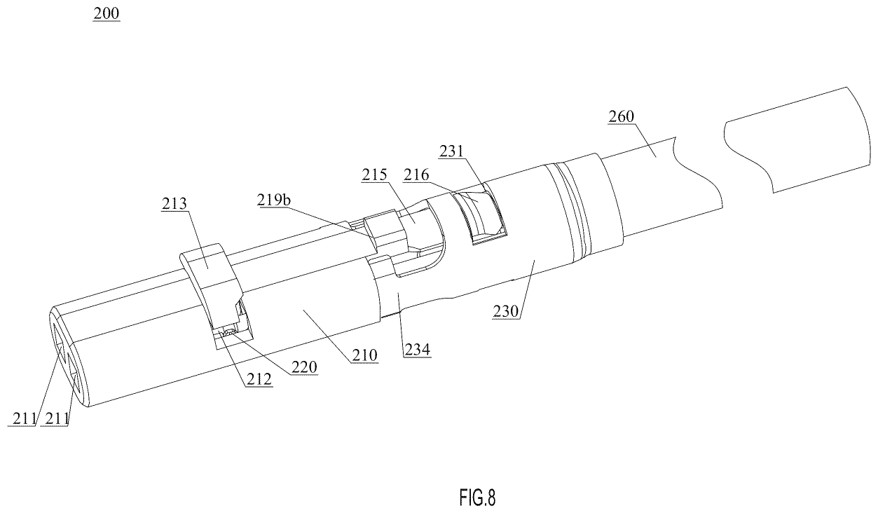

Exemplarily, the terminal position assurance component 213 may be connected with the insulative holder 210 by a connecting portion 214 before being mounted in place, as shown in FIGS. 10-11, and 13. The connecting portion 214 may be in the form of a thin strip that can be easily cut off or bent. In this way, the connecting portion 214 may be cut off or bent under an external force when the terminal position assurance component 213 is mounted in place. Optionally, the terminal position assurance component 213 may be held by the insulative holder 210 and also aligned with the opening 212 at all times before being mounted. The terminal position assurance component 213 may be integrally manufactured with the insulative holder 210. In the process of mounting, there may be no need for a robot of the production equipment to additionally grasp a separate terminal position assurance component, align the separate terminal position assurance component with the opening 212 and mount the separate terminal position assurance component. The terminal position assurance component 213 may be easily assembled by means of the connecting portion 214. Optionally, the terminal position assurance component may be separated. Optionally, one end of the connecting portion 214 may be connected to the insulative holder 210 at a position adjacent to an outer surface of the insulative holder 210, while the other end may be connected to the terminal position assurance component 213 at a position adjacent to an inner surface of the terminal position assurance component 213. The connecting portion 214 is substantially parallel to the outer surface of the insulative holder 210 before assembly. In this way, the terminal position assurance component 213 may be retained outside the opening 212 before assembly; in the process of assembly of the terminal position assurance component 213, the connecting portion 214 may also be stretched to the maximum extent, such that it is more prone to breakage or deformation. In addition, the broken or deformed connecting portion 214 may also be clamped between the terminal position assurance component 213 and the sidewalls of the opening 212, serving to fix the terminal position assurance component 213. The dimension of an inner end of the terminal position assurance component 213 facing the opening 212 may be smaller than the dimension of the opening 212, allowing the terminal position assurance component 213 to be easily aligned with the opening 212. An outer end of the terminal position assurance component 213 opposed to the inner end may be adapted to the opening 212 in size, such that the terminal position assurance component 213 may completely cover the opening 212 when it is mounted in place.

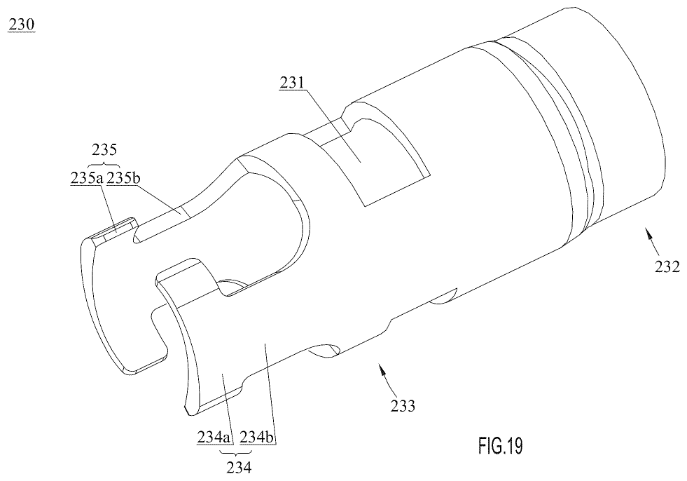

Exemplarily, as shown in FIGS. 7 and 17-18, the cable connection portion 222 may include a mounting portion 2221. The mounting portion 2221 may extend from an edge of the mating portion 221 toward the back end 102. The mating portion 221 may be solid and may be substantially cuboid-shaped. The mating portion 221 toward the mating end 101 may be configured to electrically contact the power terminal assembly of the mated electrical connector. The mounting portion 2221 may be formed by a metal sheet. Optionally, the mounting portion 2221 is in the form of steps gradually lowering along a direction parallel to the axis P-P and oriented toward the back end 102 (e.g., a direction to the right in FIGS. 18 and 19). A first portion 2221a is disposed between a second portion 2221b and the mating portion 221. The exposed wire 261 may be placed on the first portion 2221a, and the exposed insulating layer 262 and the wire 261 wrapped by the exposed insulating layer 262 may be placed on the second portion 2221b. As a result, the mounting portion 2221 can be made to be adapted to an end of the power cable 260 terminated with the power terminal 220. A cross-section of the mounting portion 2221 perpendicular to the axis P-P may be in the shape of an arc adapted to the terminated end of the power terminal 220. After the power cable 260 is placed on the mounting portion 2221, the power cable 260 may be substantially coaxial with the mating portion 221.

Optionally, the mounting portion 2221 may be provided with a first tab 2222 at a side edge. The first tab 2222 may be rectangular, trapezoidal, or of any other suitable shape, which is not limited herein. The first tab 2222 may be crimped to the wire 261 of the power cable 260. Optionally, the mounting portion 2221 and the first tab 2222 may be integrally made of a metallic material with well moldability. The first tab 2222 may be easily crimped onto the wire 261 and also be in electrical contact with the wire 261. The first tab 2222 may be disposed on the first portion 2221a of the mounting portion 2221. After the first tab 2222 is crimped onto the wire 261, it would still be protruded out of the wire 261. Thereupon, the first tab 2222 is spaced apart from the mating portion 221 to form the first recess 223. In order to securely fasten the wire 261, the first tabs 2222 may be disposed in a pair on both sides of the mounting portion 2221. Exemplarily, a pair of first tabs 2222 is symmetrically disposed on both sides of the mounting portion 2221. The first tabs 2222 on both sides may at least partially overlap with each other after being crimped onto the wire 261, to form a groove 223 with a sufficient depth. Optionally, the first tabs 2222 on both sides may not overlap with each other after being crimped onto the wire 261 but only have their distal ends adjacent to each other. In addition, by adjusting the size of the first tabs 2222, it is also possible to form desired contact areas between the first tabs 2222 and the wire 261 so as to achieve impedance matching. The first tabs 2222 may have a first dimension L1 along a direction parallel to the axis P-P. Exemplarily, the first dimension L1 may be substantially equal to or slightly shorter than the length of the exposed wire 261. The first tabs 2222 on both sides and the first portion 2221a may cooperate to fully wrap the exposed wire 261 so that the exposed wire 261 and the mounting portion 2221 are in sufficient electrical contact to reduce contact impedance.

The terminal position assurance component 213 may be embedded into the first recess 223 between the mating portion 221 and the first tabs 2222. The power terminal 220 may have simplified structure and more easily to be processed by forming the first recess 223 via the first tab 2222 crimped onto the wire 261.

Exemplarily, the mounting portion 2221 may be provided with a second tab 2223 at a side edge. The second tab 2223 may be crimped onto the exposed insulating layer 262, referring to FIG. 7 and FIGS. 17-18 in conjunction. The second tab 2223 may be disposed on the second portion 2221b. There may be a second tab 2223 or a plurality of second tabs 2223. The plurality of second tabs 2223 may be divided into one or more pairs, and second tabs 2223 of each pair are aligned along the direction parallel to the axis P-P on both side edges of the second portion 2221b. Optionally, the plurality of second tabs 2223 may also be staggered from each other along the direction parallel to the axis P-P on both side edges of the second portion 2221b, as shown in FIG. 17. The plurality of second tabs 2223 may be complementary in shape such that the insulating layer 262 can be crimped by the second tabs 2223 as much as possible, thereby ensuring firmness of the connection. Optionally, there may be no need for overlap of the plurality of second tabs 2223. Optionally, a second tab(s) 2223 may also be disposed on only one side edge of the second portion 2221b. The portion of the power cable 260 with the insulating layer 262 exposed can be fixed to the power terminal 220 by the second tabs 2223. Since the second tabs 2223 are crimped onto the insulating layer 262, there is no requirement for contact areas, as long as the portion of the power cable 260 can be firmly fixed. As shown in FIGS. 7 and 17, the second tabs 2223 may be separated from the first tabs 2222 by a distance along the direction parallel to the axis P-P. The distance may ensure that, once the terminated end of the power cable 260 is processed with a deviation that the insulating layer 262 exposed beyond the insulating sheath 263 deviates from the desired location relative to the wire 261, the first tabs 2222 can still be crimped onto the wire 261 and the second tabs 2223 can be crimped onto the exposed insulating layer 262, so as to avoid an effect on the electrical performance of the power terminal assembly 200.

Exemplarily, as shown in FIGS. 7-11 and 19-20, the ferrule 230 may be in hollow cylindrical shape. A centerline of the ferrule 230 may be parallel to the axis P-P. The ferrule 230 may be sleeved onto the power cable 260. The ferrule 230 may include a first end 232 away from the insulative holder 210 and a second end 233 proximate the insulative holder 210. The first end 232 and the second end 233 may also be opposite each other along the axis P-P. A sidewall of the ferrule 230 extends between the first end 232 and the second end 233. A opening 231 may be disposed in a portion between the first end 232 and the second end 233.

As shown in FIGS. 7 to 14, a cantilever 215 may extend from the insulative holder 210. The cantilever 215 and the insulative holder 210 may be processed by molding or connected together after being processed separately. Optionally, the insulative holder 210 may be molded integrally with an insulating material, such as plastic. The cantilever 215 may extend into the ferrule 230. Optionally, the cantilever 215 may extend along the direction parallel to the axis P-P toward the back end 102 of the housing 100. A proximal end of the cantilever 215 may be connected to the insulative holder 210. A distal end of the cantilever 215 may have a holder engaging portion 216. For example, the holder engaging portion 216 may be substantially wedge-shaped. The holder engaging portion 216 may be engaged with the opening 231 to connect the ferrule 230 with the insulative holder 210. Subsequently, the first end 232 of the ferrule 230 may be crimped onto the power cable 260. Alternatively or additionally, the cantilever 215 may engage another component such as a housing of a right angle cable connector or a board connector, for example.

Exemplarily, as shown in FIGS. 3A-3B, the insulative holder 210 may abut against an end of the insulating sheath 263. Specifically, the cantilever 215 extending into the ferrule 230 abuts against the end of the insulating sheath 263 inside the ferrule 230. In this way, the power cable 260 can be positioned accurately relative to the insulative holder 210. Moreover, the positional stability of the insulative holder 210 and the power cable 260 can be ensured in harsh environments.

Exemplarily, the cantilever 215 may include a first cantilever 2151 and a second cantilever 2152. The first cantilever 2151 and the second cantilever 2152 may be disposed opposite each other on two sides of the insulative holder 210. There may be two openings 231 for engaging with the holder engaging portions 216 on the first cantilever 2151 and the second cantilever 2152, respectively. The insulative holder 210 may be secured to the ferrule 230 by the first cantilever 2151 and the second cantilever 2152, thereby improving the stability of the connection between the two. Moreover, the first cantilever 2151 and the second cantilever 2152 disposed on two sides of the insulative holder 210 oppositely, may provide support to the ferrule 230 along the radial direction, so that the ferrule 230 can be coaxial with the insulative holder 210, further improving the stability of the connection between the two.

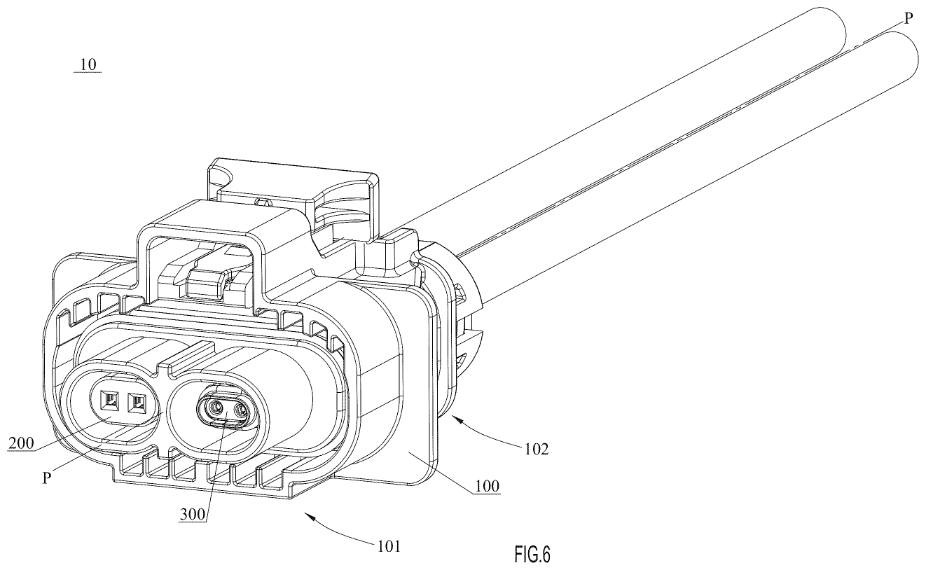

Exemplarily, the second end 233 of the ferrule 230 may be provided with terminal crimping portions, such as a first terminal crimping portion 234 and a second terminal crimping portion 235. Along a direction around the power terminal 220, the terminal crimping portions may be provided alternately with the cantilever 215, as shown in FIG. 8. The first terminal crimping portion 234 and the second terminal crimping portion 235 may extend toward the insulative holder 210. The first terminal crimping portion 234 and the second terminal crimping portion 235 may be crimped to the power terminal 220 and/or the power cable 260. Optionally, the first terminal crimping portion 234 may have the same structure as the second terminal crimping portion 235. Optionally, the first terminal crimping portion 234 and the second terminal crimping portion 235 may have different structures. In the process of assembly, after the power terminal 220 connected with the power cable 260 is inserted into the channel 211 of the insulative holder 210, the ferrule 230 sleeved on the power cable 260 may be connected to the insulative holder 210, and then the first terminal crimping portion 234 and the second terminal crimping portion 235 are crimped to the power cable 260. In this way, the power cable 260 can be further secured. Exemplarily, the power terminal 220 may be fully accommodated within the channel 211 of the insulative holder 210 to connect the power terminal 220 reliably. In the illustrated example, a portion of the exposed insulating layer 262 of the power cable 260 extends beyond the channel 211, and the first terminal crimping portion 234 and the second terminal crimping portion 235 may also be crimped onto the insulating layer 262. Optionally, the insulative holder 210 is provided with two channels 211, with each channel 211 accommodating a power terminal 220 connected to a wire 261. Two wires 261 are encased within an insulating sheath 263. The first terminal crimping portion 234 and the second terminal crimping portion 235 are crimped onto the insulating layers 262 outside the two wires 261, respectively. The two wires 261 are separable from each other because they extend beyond the insulating sheath 263. Based on the fixation of the two wires 261 by the first terminal crimping portion 234 and the second terminal crimping portion 235 respectively, various portions of the power cable 260 are reliably fixed.

As shown in FIG. 7, the first terminal crimping portion 234 may be disposed on one side between the first cantilever 2151 and the second cantilever 2152. The second terminal crimping portion 235 may be disposed on the other side between the first cantilever 2151 and the second cantilever 2152. Optionally, the first terminal crimping portion 234, the first cantilever 2151, the second terminal crimping portion 235 and the second cantilever 2152 may be disposed sequentially along the direction around the power terminal 220. The first terminal crimping portion 234 and the second terminal crimping portion 235 are disposed within gaps on two sides of the first cantilever 2151 and the second cantilever 2152, respectively. Accordingly, the overall dimension of the power terminal assembly 200 can be relatively reduced, and an outer surface of the power terminal assembly 200 can be made relatively flat, so that the outer contour of the power terminal assembly 200 may have a higher degree of consistency with the outer contour of the signal terminal assembly 300. As shown in FIG. 8, for example, the terminal crimping portions including the first terminal crimping portion 234 and the second terminal crimping portion 235 may abut against the insulative holder 210 along an extension direction of the axis P-P, and almost no slit is left between the terminal crimping portions and the insulative holder 210.

Although in the illustrated embodiment, two terminal crimping portions are provided, such as the first terminal crimping portion 234 and the second terminal crimping portion 235, optionally, there may be a terminal crimping portion, or three or more terminal crimping portions.

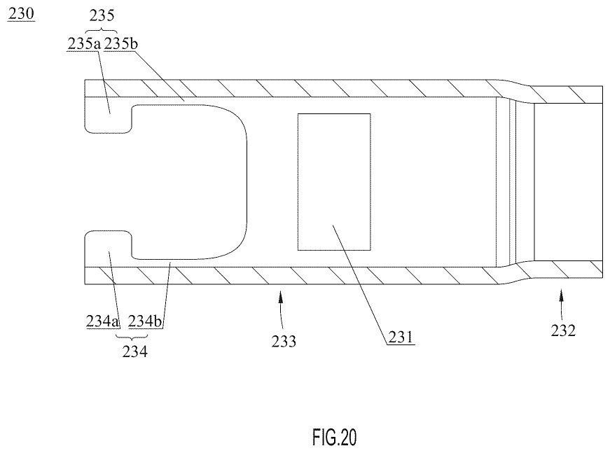

Exemplarily, as shown in FIGS. 19-20, the first terminal crimping portion 234 may include a first curved tab 234a and a first connecting portion 234b. The first curved tab 234a may extend about the axis P-P. The first connecting portion 234b may be connected between the first curved tab 234a and the second end 233 of the ferrule 230. The first connecting portion 234b and the first curved tab 234a may be connected into a T-shape. The first terminal crimping portion 234 and the ferrule 230 may be integrally processed by molding or connected together after being processed separately. The first curved tab 234a may be crimped to the power terminal 220 and/or the power cable 260 connected to the power terminal 220. As previously described, the first curved tab 234a may be crimped to an exposed portion of one insulating layer 262 of the power cable 260. Both ends of the first curved tabs 234a may be freely bent and crimped onto the insulating layer 262.

Exemplarily, the second terminal crimping portion 235 may include a second curved tab 235a and a second connecting portion 235b. The second curved tab 235a may extend about the axis P-P. The second connecting portion 235b may be connected between the second curved tab 235a and the second end 233 of the ferrule 230. The second connecting portion 235b and the second curved tab 235a may be connected into a T-shape. The second terminal crimping portion 235 and the ferrule 230 may be integrally processed by molding or connected together after being processed separately. The second curved tab 235a may be crimped to the power terminal 220 and/or the power cable 260 connected to the power terminal 220. As previously described, the second curved tab 235a may be crimped to an exposed portion of the other insulating layer 262 of the power cable 260. Both ends of the second curved tabs 235a may be freely bent and crimped onto the insulating layer 262.

In this way, the first curved tab 234a and the second curved tab 235a can serve to limit and fix the two wires 261 within the power cable 260, respectively, even under harsh environmental conditions. The stability of the electrical connector 10 may be improved.

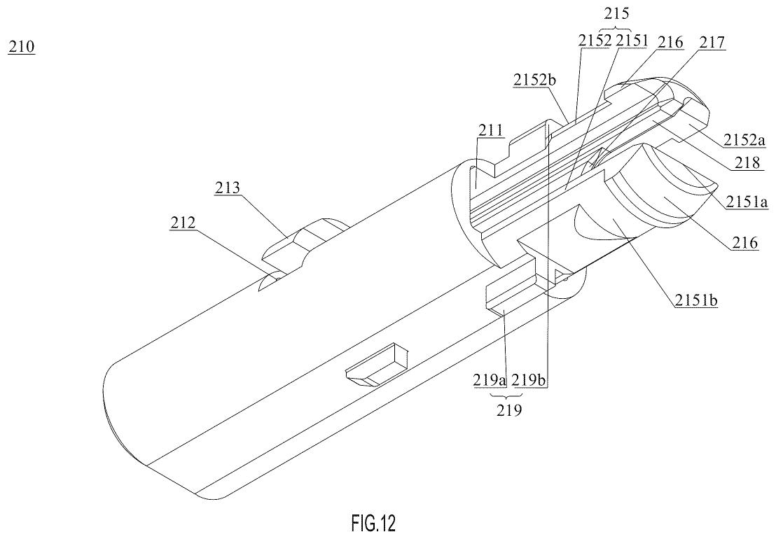

Exemplarily, there may be a plurality of channels 211 in the insulative holder 210, such as, two channels 211 for accommodating a power terminal 220 connected to a positive wire and a power terminal 220 connected to a negative wire. The plurality of channels 211 may also be arranged side-by-side along a direction perpendicular to the axis P-P. The channels 211 may have the same structure. The power terminals 220 may also have the same structure. A terminal position assurance component 213 may lock a plurality of power terminals 220 simultaneously. In order to form the plurality of channels 211, a divider 217 may be provided inside the insulative holder 210 as shown in FIG. 7 and FIGS. 13-14. It needs to be clarified that the divider 217 may be a single member that penetrates substantially through the insulative holder 210 along the direction parallel to the axis P-P to completely separate adjacent channels 211. Optionally, the divider 217 may further include a plurality of split members spaced apart along the direction parallel to the axis P-P. The divider 217 is primarily used to space adjacent power terminals 220 apart to ensure that the adjacent power terminals 220 are electrically insulated from each other. Optionally, the divider 217 may extend beyond the insulative holder 210, for example, it may extend to the middle of the cantilevers 215 along the direction parallel to the axis P-P, as shown in FIG. 13. In this way, the divider 217 may also serve to reinforce the strength of the cantilevers 215. It should be noted that in order to ensure the insulating performance, the wire 261 exposed from the insulating sheath 263 is preferably completely accommodated within the channel 211. A portion of the divider 217 exposed beyond the insulative holder 210 may also be used to separate the wires 261 covered with the insulating layers 262, whereby this portion of the divider 217 may also provide insulation between the wires 261 to avoid breakdown in case of excessive current. Optionally, the divider 217 does not extend through the entire cantilever 215, but only extends to the middle of the cantilever 215 to ensure that the cantilever 215 is sufficiently resilient to be inserted into the ferrule 230 for engaging with the opening 231. Where the cantilever 215 includes the first cantilever 2151 and the second cantilever 2152, the divider 217 may be connected between the first cantilever 2151 and the second cantilever 2152.

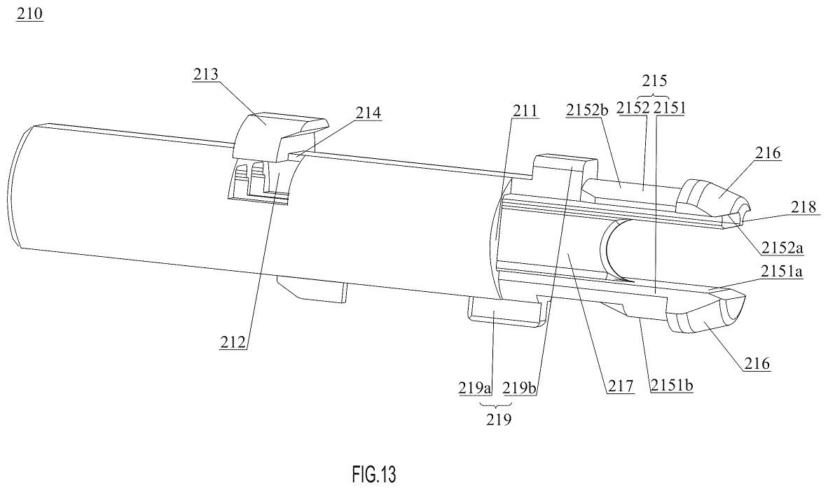

Exemplarily, as shown in FIGS. 13 to 14, the first cantilever 2151 may have a first inner surface 2151a and a first outer surface 2151b. The first inner surface 2151a faces the power terminal 220, and the first outer surface 2151b is back to the power terminal 220. Optionally, the first inner surface 2151a may be flat, such that the first inner surface 2151a is easily processed. Optionally, the first inner surface 2151a may be curved. The shape of the first inner surface 2151a is adapted to the outer contour of the power terminal 220. Optionally, the first outer surface 2151b may be a curved surface, which may have a similar curvature as an inner surface of the ferrule 230. The second cantilever 2152 may have a second inner surface 2152a and a second outer surface 2152b. The second inner surface 2152a faces the power terminal 220. The second outer surface 2152b is back to the power terminal 220. Similarly, Optionally, the second inner surface 2152a may be flat, such that the second inner surface 2152a is easily processed. Optionally, the second inner surface 2152a may also be curved. The shape of the second inner surface 2152a is adapted to the outer contour of the power terminal 220. Optionally, the second outer surface 2152b may be a curved surface that may have a similar curvature as the inner surface of the ferrule 230. In this way, the second end 233 of the ferrule 230 can be sleeved onto the first cantilever 2151 and the second cantilever 2152.

A rib 218 may be disposed on the second inner surface 2152a. The rib 218 may be connected to the divider 217 and be parallel to the axis P-P. The rib 218 may have the same cross-section along the direction of the axis P-P. The rib 218 may be disposed substantially between the wires 261 covering with the insulating layers 262 but without the insulating sheath 263. Due to the rib 218, a thickness of the first cantilever 2151 (which is represented by a maximum distance H1 from the first inner surface 2151a to the first outer surface 2151b, as shown in FIG. 14) may be greater than a thickness of the second cantilever 2152 (which is represented by a maximum distance H2 from the second inner surface 2152a to the second outer surface 2152b). The rib 218 may serve to reinforce the mechanical strength of the second cantilever 2152 to compensate for the lack of thickness of the first cantilever 2151, while the first cantilever 2151 on the other side may have a sufficiently large thickness to ensure its mechanical strength. In this way, the insulative holder 210 can be minimized without impairing the mechanical strength, and thus the power terminal assembly 200 can be more compact.

Exemplarily, as shown in FIG. 7, the first tab 2222 crimped onto the wire 261 of the power cable 260 may face the second inner surface 2152a. As previously described, the first tabs 2222 may be provided in a pair and optionally overlapped, resulting in a greater thickness there. The smaller thickness of the second cantilever 2152 may allow a space for the first tab 2222 to pass through and still ensure the power terminal 220 and the wire 261 to be coaxial with the insulative holder 210.

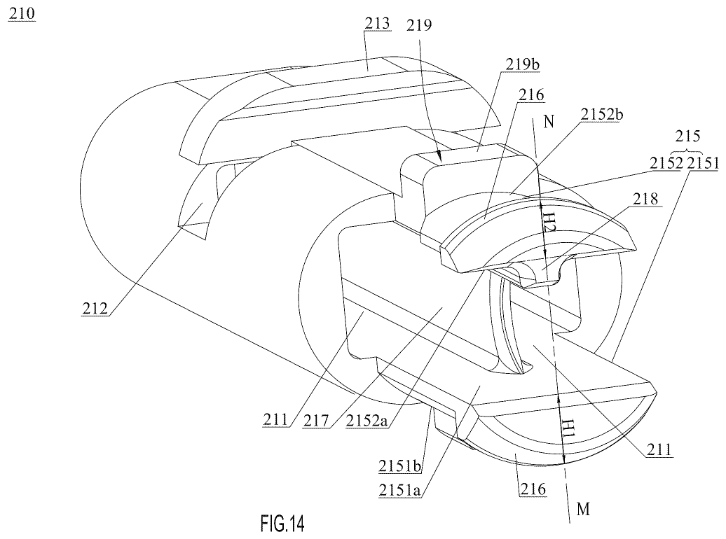

Exemplarily, as shown in FIG. 15, a cross-section of the insulative holder 210 perpendicular to the axis P-P may be an elliptical shape. The elliptical shape has a first side and a second side opposite each other along its short axis M-N. In the illustrated example, the first side is marked by M and the second side is marked by N. The two power terminals 220 are disposed side-by-side along a long axis of the elliptical shape, resulting in the insulative holder 210 having a larger size along a direction of the long axis. Referring to FIG. 7 in conjunction, the cantilever 215 may be disposed on the first side M and/or the second side N. Optionally, the power cable 260 has a circular cross-section. The ferrule 230 is substantially in hollow cylindrical shape. A portion of the insulating sheath 263 enclosed by the second end 233 of the ferrule 230, the first terminal crimping portion 234 and the second terminal crimping portion 235 is removed, so that spaces may be left on two side (e.g., an upper side and a lower side in FIG. 7) of the two wires 261 covered with the insulating layers 262. The spaces may be sufficient for the cantilever 215, for example, for the first cantilever 2151 and the second cantilever 2152, respectively. Thus, the power terminal assembly 200 can be more compact and be inconsistent with the signal terminal assembly 300 in outer contour, by disposing the cantilever 215 on the first side and/or the second side opposite each other along the short axis M-N.

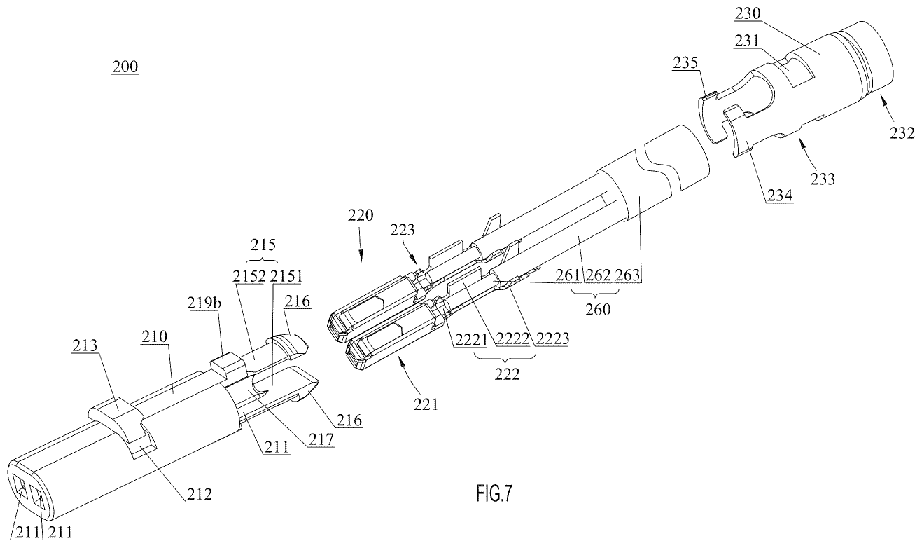

Exemplarily, a projection 219 may be disposed on the outer surface of the first side M and/or the outer surface of the second side N, as shown in FIGS. 9 and 10. The projection 219 may be substantially square, trapezoidal, curved, etc., which is not limited herein. The projection 219 may be locked with the housing 100. Since the insulative holder 210 may have a smaller dimension along the direction of the short axis MN, the projection 219 on the outer surface of the first side M and/or the outer surface of the second side N can make the structure of the power terminal assembly 200 more compact. Moreover, a projection, such as a first projection 310 and a second projection 320, is disposed at a corresponding position on the signal terminal assembly 300, as described hereinafter. Thus, it may enable the power terminal assembly 200 to be mounted into the housing 100.

Position assurances of the signal terminal assembly 300 and the power terminal assembly 200 in the housing 100 will be further described with reference to the accompanying drawings. Exemplarily, in FIGS. 1A-1B, FIG. 2, and FIGS. 3A-3B, the housing 100 may comprise a main housing 110. A contact position assurance component may be disposed in the main housing 110. The signal terminal assembly 300 and the power terminal assembly 200 may be retained in the main housing 110 by the contact position assurance component.

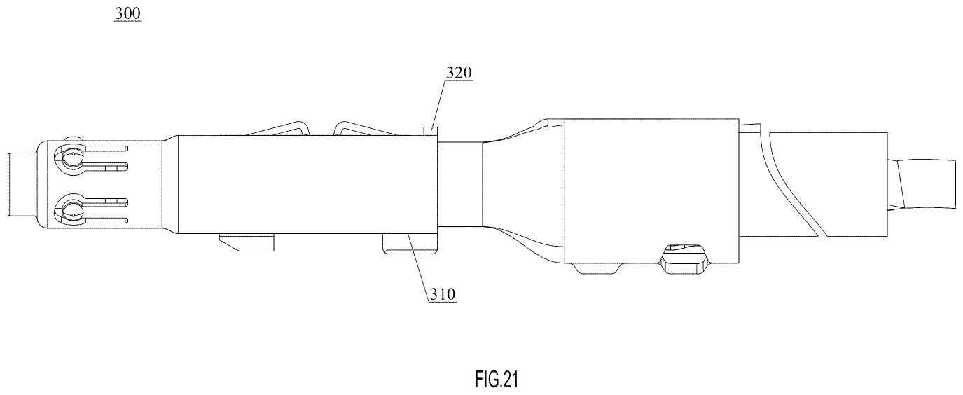

Exemplarily, as shown in FIG. 3B and FIGS. 11-13, a first projection 219a may be disposed on the outer sidewall of the power terminal assembly 200. The first projection 219a may be substantially square, trapezoidal, curved, etc., which is not limited herein. The first projection 219a may be integrated with the outer sidewall of the power terminal assembly 200 by molding, or attached to the outer sidewall after being processed separately. As shown in FIG. 21, a first projection 310 may be disposed on the outer sidewall of a shield of the signal terminal assembly 300. The first projection 310 may be substantially square, trapezoidal, curved, etc., which is not limited herein. The first projection 310 and the first projection 219a may be disposed at corresponding positions on the respective terminal assemblies such that the portions of the signal terminal assembly 300 and the power terminal assembly 200 accommodating inside the housing 100 have the same outer contour. The signal terminal assembly 300 may be configured similar to a signal terminal assembly described in U.S. application Ser. No. 17/900,563, the contents of which is herein incorporated in reference in its entirety.

Optionally, as shown in FIG. 4, the contact position assurance component may include one or more latches 112 disposed inside the main housing 110. Each latch 112 may extend toward the back end 102. Exemplarily, the latch 112 and the main housing 110 may be integrally processed by molding. A distal end of the latch 112 may have a housing engaging portion 1121. The first projection 219a and the first projection 310 may be engaged with a housing engaging portion 1121 or two housing engaging portions 1121 to prevent the power terminal assembly 200 and the signal terminal assembly 300 from exiting the main housing 110. In the process of insertion of the signal terminal assembly 300 and the power terminal assembly 200 from the back end 102 into the cavity 103, the first projection 310 and the first projection 219a may first cross over the housing engaging portion 1121, and finally the first projection 310 and the first projection 219a may be engaged with the housing engaging portion 1121. At this time, the housing engaging portion 1121 may be disposed between the first projection 219a and the back end 102, and between the first projection 310 and the back end 102, such that the first projection 310 and the first projection 219a may be prevented from moving toward the back end 102. With this configuration, the latch 112 has sufficient mechanical strength because of its sufficient width. The first projection 219a is locked in place by the latch 112, such that the power terminal assembly 200 can be securely fixed inside the main housing 110.

Exemplarily, a second projection 219b may be disposed on the outer sidewall of the power terminal assembly 200, as shown in FIGS. 3B, 7-11, 13. A second projection 320 may be disposed on the outer sidewall of the signal terminal assembly 300, as shown in FIG. 21. The second projection 320 and the second projection 219b may be disposed at corresponding positions on the respective terminal assemblies such that the portions of the signal terminal assembly 300 and the power terminal assembly 200 mounted inside the housing 100 have the same outer contour. The contact position assurance component may include a protruding portion 140 disposed inside the main housing 110, as shown in FIGS. 3B and 4. The second projection 219b and the second projection 320 may abut against the protruding portion 140. The protruding portion 140 may limit the second projection 320 and the second projection 219b along a direction toward the mating end 101. The protruding portion 140 may be an annular flange that surrounds the signal terminal assembly 300 and the power terminal assembly 200. Optionally, separate protruding portions 140 may be provided for the signal terminal assembly 300 and the power terminal assembly 200, respectively. Optionally, the protruding portions 140 of the signal terminal assembly 300 and the power terminal assembly 200 may also be connected as one piece. An end where the mating end 101 is located may be referred to as a front end, and an end where the back end 102 is located may be referred to as a rear end. The protruding portion 140 may limit the positions of the signal terminal assembly 300 and the power terminal assembly 200 at the front end, and the housing engaging portion 1121 may limit the positions of the signal terminal assembly 300 and the power terminal assembly 200 at the rear end. The signal terminal assembly 300 and power terminal assembly 200 can thus be securely retained in the main housing 110.

Exemplarily, as shown in FIGS. 3B and 4, a gap 104 may be provided between an inner sidewall of the main housing 110 and the latch 112. When the power terminal assembly 200 and/or the signal terminal assembly 300 are inserted into the main housing 110 from the back end 102, the first projection 310 and/or the first projection 219a extrude outwardly against the housing engaging portion 1121 of the latch 112 into the gap 104. After the first projection 310 and the first projections 219a have completely crossed over the housing engaging portion 1121, the housing engaging portion 1121 may return to the initial position to be engaged with the first projection 310 and the first projection 219a.

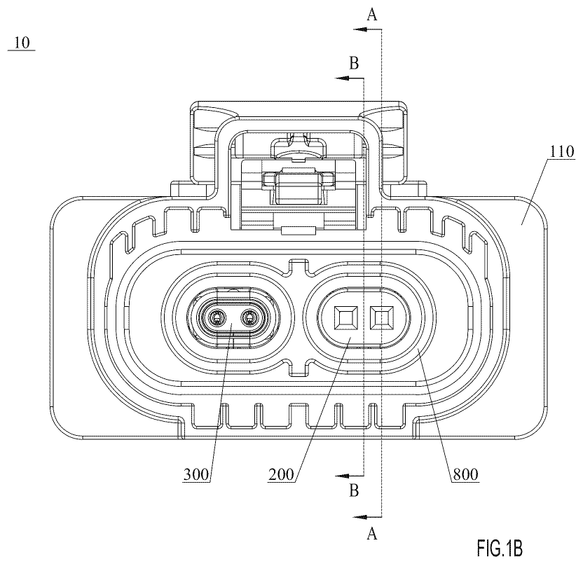

As shown in FIGS. 2, 3A-3B and 4, the housing 100 may further include a position assurance component 120. The position assurance component 120 may be inserted into the main housing 110. The position assurance component 120 and the main housing 110 may together form the cavity 103. A front portion of the power terminal assembly 200 and that of the signal terminal assembly 300 may be inserted into the main housing 110. A rear portion of the power terminal assembly 200 and that of the signal terminal assembly 300 may be inserted into the position assurance component 120. The position assurance component 120 may be made of a material that may have a dielectric constant configured to provide sufficient isolation between high speed signal paths and power paths.

The position assurance component 120 may be inserted into the gap 104. The power terminal assembly 200 and the signal terminal assembly 300 may be inserted in place in the main housing 110, before the position assurance component 120 may be inserted into the gap 104 of the main housing 110. Optionally, the position assurance component 120 may be pre-sleeved onto the power terminal assembly 200 and the signal terminal assembly 300.

Optionally, the power terminal assembly 200 and the signal terminal assembly 300 are engaged with the housing engaging portion 1121 on the main housing 110, and the position assurance component 120 is then mounted in place. In this way, the position assurance component 120 may be sandwiched between the latch 112 and the inner sidewall of the main housing 110, as shown in FIG. 3B, for blocking the latch 112 from deformation. Even if the electrical connector 10 is applied to harsh environments, such as high speeds, vibrations, etc., the housing engaging portion 1121 cannot enter into the gap 104. Optionally, when the power terminal assembly 200 and/or the signal terminal assembly 300 are inserted into the main housing 110 from the back end 102, the gap 104 may provide a movable space for the latch 112, which facilitates the mounting. When the position assurance component 120 is inserted into the gap 104, the power terminal assembly 200 and/or the signal terminal assembly 300 can be reliably connected with the main housing 110.

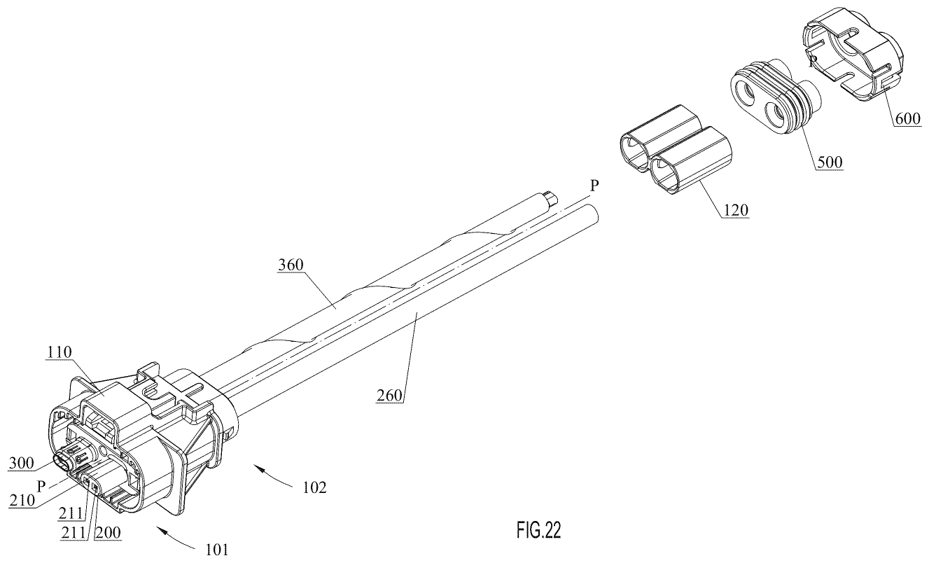

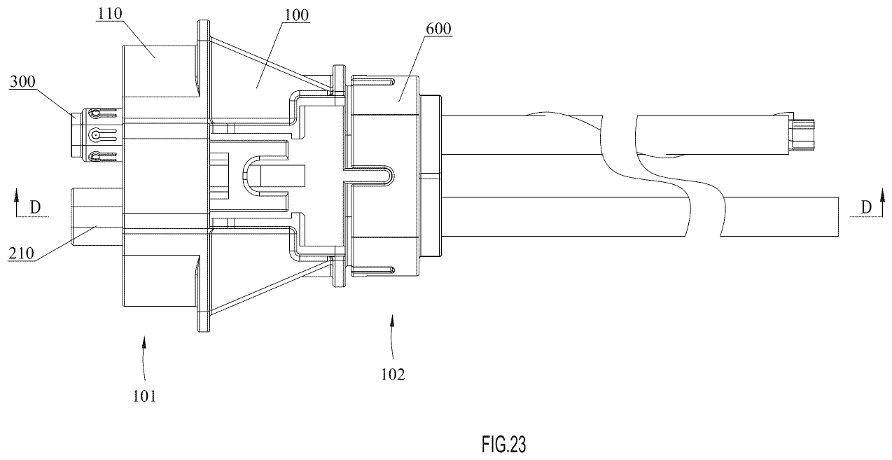

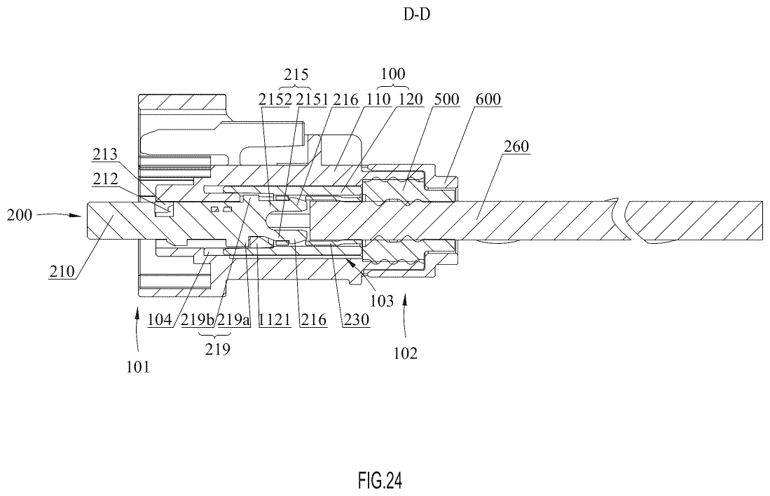

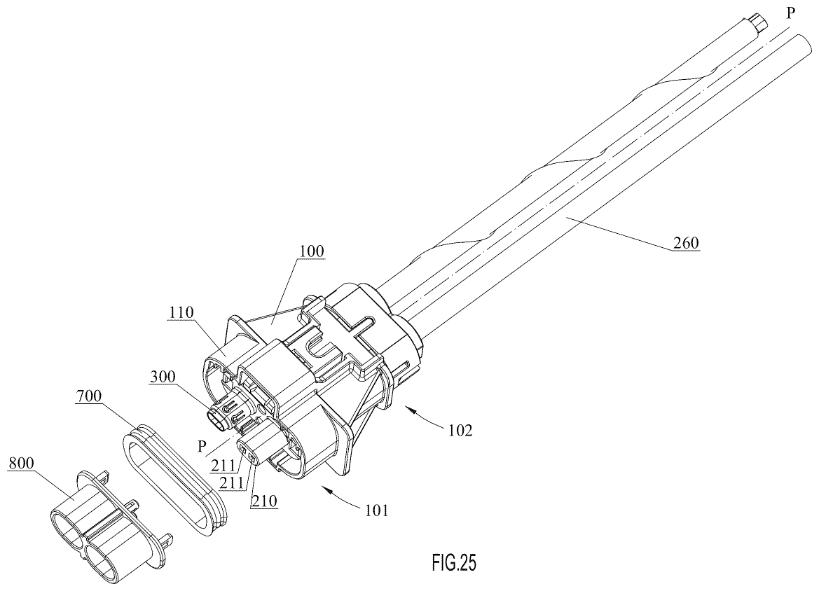

FIGS. 22-25 illustrate the assembly process of the power terminal assembly 200, the signal terminal assembly 300, the housing 100, the rear cover 600 and the front cover 800. As shown in FIG. 22, the power terminal assembly 200 connected with the power cable 260 and the signal terminal assembly 300 connected with the signal cable 360 are mounted into the main housing 110, until the first projection 310 and the first projection 219a are engaged to the housing engaging portion 1121, and the second projection 320 and the second projection 219b abut against the protruding portion 140. Then, the position assurance component 120 is inserted into the main housing 110, until the position assurance component 120 enters into the gap 104 between the inner sidewall of the main housing 110 and the latch 112, as shown in FIG. 24. The rear seal 500 and the rear cover 600 are then mounted sequentially to the rear end of the main housing 110, as shown in FIG. 23. Finally, the front seal 700 and the front cover 800 may be mounted sequentially to the front end of the main housing 110, as shown in FIG. 25.

The present disclosure has been described by the above embodiments, but it should be understood that a variety of variations, modifications and improvements may be made according to the teaching of the present disclosure by those skilled in the art, and all of these variations, modifications and improvements fall within the spirit and the scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

Moreover, although many creative aspects have been described above with reference to the cable connector, it should be understood that the aspects of the present disclosure are not limited to these. Any one of the creative features, whether alone or combined with one or more other creative features, can also be used for other types of connectors, such as circuit board connectors. Also, the electrical connectors can be used as plug connectors or socket connectors, etc. The electrical connectors can be vertical connectors or right-angle connectors.

In the description of the present disclosure, it is to be understood that orientation or positional relationships indicated by orientation words “front”, “rear”, “upper”, “lower”, “left”, “right”, “transverse direction”, “longitudinal direction”, “vertical direction”, “perpendicular”, “horizontal”, “top”, “bottom” and the like usually are shown based on the accompanying drawings, only for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. An electrical connector comprising:
a housing comprising a mating end, a back end opposite the mating end, a first cavity extending from the mating end toward the back and a second like cavity extending from the mating end toward the back;
a signal terminal assembly disposed in the first cavity and comprising a signal terminal, and a shield substantially encircling the signal terminal; and
a power terminal assembly disposed in the second cavity and comprising an insulative holder, and a power terminal held in the insulative holder,
wherein the first and second cavities are symmetrical to each other such that the signal terminal assembly and power terminal assembly are interchangeable in the first and second cavities.

2. The electrical connector of claim 1, comprising:
a front cover comprising first and second openings disposed corresponding to the first and second cavities of the housing such that mating portions of the signal terminal assembly and power terminal assembly extend into respective openings of the front cover.

3. The electrical connector of claim 2, wherein:
the first and second openings of the front cover are symmetrical to each other such that the signal terminal assembly and power terminal assembly are interchangeable in the first and second cavities.

4. The electrical connector of claim 2, comprising:
a front seal disposed adjacent the front cover and abutting an annular surface of the housing.

5. The electrical connector of claim 2, comprising:
a position assurance component disposed in the housing and comprising third and fourth openings disposed corresponding to the first and second cavities of the housing such that cables ends of the signal terminal assembly and power terminal assembly extend into respective openings of the position assurance component.

6. The electrical connector of claim 5, wherein:
the third and fourth openings of the position assurance component are symmetrical to each other such that the signal terminal assembly and power terminal assembly are interchangeable in the first and second cavities.

7. The electrical connector of claim 5, wherein:
the signal terminal assembly comprises a signal cable having an end attached to the signal terminal and substantially encircled by the shield of the signal terminal assembly;
the power terminal assembly comprises a power cable having an end attached to the power terminal; and
the electrical connector comprises a rear seal abutting the position assurance component and comprising fifth and sixth openings disposed corresponding to the third and fourth openings of the position assurance component such that the signal cable and power cable extend through the fifth and sixth openings of the rear seal.

8. The electrical connector of claim 7, comprising:
a rear cover at least partially enclosing the rear seal and comprising seventh and eighth openings disposed corresponding to the fifth and sixth openings of the rear seal such that the signal cable and power cable extend out of the rear cover.

9. A power terminal assembly comprising:
an insulative holder comprising a body with an elliptical cross section with a major axis, the body enclosing first and second channels and comprising a projection extending from the body orthogonally to the major axis; and
a plurality of power terminals disposed within the first and second channels, each of the plurality of power terminals comprising a cuboid-shaped mating portion and a mounting portion configured to make electrical and mechanical connection to a power conductor.

10. The power terminal assembly of claim 9, wherein:
the insulative holder comprises first and second cantilevers extending from top and bottom of the body respectively; and
the first and second cantilevers are each configured for engaging a support structure configured for supporting the power conductors positioned for electrical and mechanical connection to power terminals of the plurality of power terminals.

11. The power terminal assembly of claim 9, wherein:
for each of the plurality of power terminals, the mounting portion comprises a sheet and first and second tabs extending from opposite sides of the sheet.

12. The power terminal assembly of claim 10, comprising:
a ferrule comprising first and second curved tabs crimping the insulative holder from left and right and features at top and bottom engaging distal ends of the first and second cantilevers of the insulative holder so as to retain the pair of power terminals in position.

13. The power terminal assembly of claim 11, wherein:
the insulative holder comprises an opening at the top, the opening aligned with recesses between the cuboid-shaped mating portions and the first and second tabs of each of the plurality of power terminals; and
the power terminal assembly comprises a terminal position assurance component disposed in the opening at the top of the insulative holder and extending into the recesses of each of the plurality of power terminals.

14. The power terminal assembly of claim 11, comprising:
a power cable comprising a plurality of wires attached to respective mounting portions of the plurality of power terminals, wherein:
the first and second tabs of the plurality of power terminals wrap respective wires of the pair of wires.

15. The power terminal assembly of claim 14, wherein:
each of the plurality of power terminals comprises third and fourth tabs extending from the opposite sides of the sheet; and
the power cable comprises insulative layers enclosing respective wires of the plurality of wires and wrapped by the third and fourth tabs of respective power terminals of the plurality of power terminals.

16. The power terminal assembly of claim 15, wherein:
the power cable comprises a sheath enclosing the insulative layers; and
a rear end of the ferrule crimps the sheath.

17. The power terminal assembly of claim 12, wherein:
the insulative holder has an elliptical cross-section; and
the ferrule is in hollow cylindrical shape.

18. An electrical connector comprising:
a housing comprising a mating end, a back opposite the mating end, first and second cavities extending from the mating end toward the back, and first and second latches inside the housing and having distal ends;
a signal terminal assembly configured for insertion in the first cavity and engaging the first latch;
a power terminal assembly configured for insertion in the second cavity and engaging the second latch; and
a position assurance component disposed in the housing and comprising
a first portion comprising a first opening configured to receive the distal end of the first latch and a second opening configured to receive the signal terminal assembly when the position assurance component is in an engaged position and
a second portion comprising a third opening configured to receive the distal end of portion of the second latch and a fourth opening configured to receive the power terminal assembly when the position assurance component is in the engaged position.

19. The electrical connector of claim 18, wherein:
the power terminal assembly is configured for insertion in the first cavity and engaging the first latch; and
the signal terminal assembly is configured for insertion in the second cavity and engaging the second latch.

20. The electrical connector of claim 18, wherein:
each of the signal terminal assembly and power terminal assembly comprises a projection extending downward;
the first latch of the housing comprises a protrusion at the distal end and engaging the projection of the signal terminal assembly; and
the second latch of the housing comprises a protrusion at the distal end and engaging the projection of the power terminal assembly.
